(19) United States
(12) Patent Application Publication
(10) Pub. No.: US 2025/0190641 A1
(43) Pub. Date: Jun. 12, 2025

(54) SYSTEM AND METHOD FOR AI-POWERED LOT SUBDIVISION OPTIMIZATION AND VISUALIZATION OF A REAL PROPERTY BASED ON GOVERNMENTAL REGULATORY FRAMEWORK

(71) Applicant: Raj Abhyanker, Cupertino, CA (US)

(72) Inventor: Raj Abhyanker, Cupertino, CA (US)

(21) Appl. No.: 18/391,718

(22) Filed: Dec. 21, 2023

Related U.S. Application Data
(60) Provisional application No. 63/606,603, filed on Dec. 6, 2023.

(51) Int. Cl. G06F 30/13; G06F 30/27; G06Q 50/16; G06T 19/00

(52) U.S. Cl. CPC G06F 30/13; G06F 30/27; G06Q 50/165; G06T 19/003

(57) ABSTRACT

A land-use planning system includes a data collection module configured to extract a shape file associated with a property address of a plot of real property in a jurisdiction. The shape file includes a location, a geometry, and attribution of a point, a line, and/or a polygon features of the plot of real property. An artificial intelligence (AI) model is adapted to analyze the shape file. The AI model is fine-tuned based on a regulation governing lot subdivision in the jurisdiction. A recommendation engine is integrated with the AI model to generate an optimal plot boundary suggestion to adhere to the governmental regulation while maximizing financial viability of split lots from the property address. A visualization component creates a visual representation of the split lots in the jurisdiction displaying the optimal plot boundary suggestion on a rendering of the shape file.

### CLAIM OF PRIORITY

This application is a U.S. Utility Conversion Patent Application of U.S. Provisional Patent Application No. 63/606,603 titled ‘SYSTEM AND METHOD FOR AI-POWERED SUBDIVISION OPTIMIZATION AND VISUALIZATION’ filed on Dec. 6, 2023. The content of the aforementioned application is incorporated by reference in entirety thereof.

### FIELD OF TECHNOLOGY

This disclosure relates generally to an optimal split of a plot of real property using an artificial intelligence based algorithm optimized based on governmental regulatory framework.

### BACKGROUND

In states like California, the housing market faces significant challenges due to a complex web of land-use regulations and zoning laws, creating formidable barriers to the construction of new housing units. These obstacles have largely arisen from local governments' adoption of stringent zoning policies, which prioritize single-family homes and discourage the development of multi-family or high-density housing. Consequently, these policies have impeded efforts to expand the housing supply and adapt to shifting demographic needs.

In response to the persistent housing crisis, lawmakers in various states have introduced legislative measures aimed at addressing the issue. In California, for instance, Senate Bill 9 (SB9) was introduced in 2022 as a legislative effort to tackle this crisis head-on. SB9 sought to boost housing density within existing neighborhoods by permitting the division of single-family lots into two and easing restrictions on accessory dwelling units (ADUs). Similar initiatives have been adopted or are pending in numerous states.

However, despite the adoption of such forward-thinking laws, homeowners often encounter formidable challenges when navigating the complexities of property development under these regulations. Specifically, they grapple with assessing the financial viability, technical feasibility, and budgetary requirements associated with splitting their lots or embarking on property development projects.

For instance, the process of evaluating the eligibility of a property under SB9 (and similar statutes) necessitates the analysis of extensive government data, encompassing public records, geospatial plot files, assessor information, zoning details, state legal codes, and municipal regulations. Each facet of this multifaceted process demands specialized skills, typically accompanied by significant costs.

Homeowners may find themselves in unfamiliar territory when trying to decipher zoning regulations or seeking assistance from land use planners and zoning experts. The intricate landscape of local zoning codes, zoning maps, and land use regulations can be bewildering, making it challenging to determine whether a property aligns with SB9 requirements. In California, the cost of engaging these experts can vary substantially, ranging from a few thousand dollars to tens of thousands of dollars.

Additionally, navigating local ordinances and regulations often involves reviewing and interpreting municipal and state laws, which can be a complex endeavor. Homeowners may lack the necessary knowledge and experience to undertake this task accurately. Legal fees in California exhibit considerable variability but tend to fall within the range of a few thousand dollars to tens of thousands of dollars, contingent on the intricacy of the legal review.

Furthermore, these processes may entail a series of logistical steps, such as scheduling planning meetings, attending hearings, and coordinating with city government officials. These operational and financial challenges, especially daunting for those with limited resources, can act as a deterrent, discouraging landowners from pursuing lot splitting or property development under SB9 (and similar statutes). Consequently, despite SB9's laudable goal of enhancing housing density and affordability, the substantial costs linked to regulatory compliance may curb its effectiveness in encouraging landowners to capitalize on this legislation.

### SUMMARY

Disclosed are a method and/or a system to an optimal split of a plot of real property using an artificial intelligence based algorithm optimized based on governmental regulatory framework.

In one aspect, a land-use planning system includes a data collection module configured to extract a shape file associated with a property address of a plot of real property in a jurisdiction. The shape file includes a location, a geometry, and a attribution of a point, a line, and/or a polygon feature of the plot of real property. An artificial intelligence (AI) model is adapted to analyze the shape file. The AI model is fine-tuned based on a regulation governing lot subdivision in the jurisdiction. A recommendation engine is integrated with the AI model to generate an optimal plot boundary suggestion to adhere to the governmental regulation while maximizing financial viability of split lots from the property address. A visualization component creates a visual representation of the split lots in the jurisdiction displaying the optimal plot boundary suggestion on a rendering of the shape file.

A data preprocessing component may be configured to standardize and clean a collected geospatial property information, a zoning regulation, a property tax record, and an owner data using a zoning classification module. The AI model's fine-tuning may be continuously updated to accommodate changes in a state and a municipal regulation related to lot subdivision. The recommendation engine considers additional factors, including a property age, a market trend, and/or a demographic data, when generating the optimal plot boundary suggestions to maximize financial viability. The visualization component to generate a 3D massing diagram that adheres to local zoning and planning guidelines, showcasing the proposed lot divisions in a visually compelling manner. The system may include transmitting the recommended optimal plot boundaries to a property owner and a developer via electronic communication for review and consideration.

The fine-tuning of the AI model may involve a adjusting hyperparameter, including learning rates and batch sizes to optimize its performance for the lot subdivision recommendations. The data collection module may use a generative AI module to allow users to input data in a plain language. A user interface of the visualization component may allow for an interactive query about a plot boundary adjustment and provides a realtime AI-generated feedback. The system may include a feature to generate an executive summary using a generative AI to explain a rationale behind the plot boundary recommendations. Further, the system may include an integrated market analysis module to leverage a real-time real estate market data to provide the user with predictions on the future value of the subdivided lot for making an informed decision on selling and developing a lot. Furthermore, the system may include a community impact assessment tool to analyze and predict the impact of the proposed lot split on the local community, including effects on traffic, schools, and public services for presentation to a zoning board and/or a community group.

In addition, the system may include an environmental module implemented using the AI to identify and preserve natural features on the lot, such as trees, water bodies, and topography to ensure that lot subdivision plans are environmentally sustainable. The generative AI may include VR capabilities to allow the user to “walk through” the proposed subdivided lots and surrounding areas, providing a more tangible understanding of the space and its potential. The system may include the generative AI to automatically generate the necessary legal and regulatory documents for submission based on the proposed lot split plan to simplify the process of obtaining approvals, automatically suggest lot split plans that preserve the historical character of the property while still meeting modern development needs based on an AI-driven analysis, and equally led with data to analyze natural disaster data and suggest lot split plans that enhance the resilience of homes and infrastructure to the events such as floods, wildfires, and/or earthquakes.

The system may be integrated with utility mapping and analysis to ensure that subdivided lots optimize the use of existing infrastructure, such as water, sewer, and electrical grids, and plan for the efficient placement of new services. The system may utilize a specialized algorithm to propose the placement of ADUs on existing lots, considering the potential for a rental income, a guest housing, and/or a multigenerational living space. The system may suggest negotiation strategies for property owners to use with a neighbor and/or a local authority based on previous successful negotiations and current regulatory environments. The system may customize an aesthetic algorithm to suggest lot divisions based on aesthetic preferences, incorporating architectural styles, sightlines, and other design elements that align with the character of an existing neighborhood.

In another aspect, a method for recommending a optimal plot boundary in lot subdivision includes collecting a geospatial property information, a zoning regulation, a property tax record, and an owner data. The method includes training an AI model to process said the geospatial property information. The AI model is fine-tuned based on a state and a municipal regulation governing a lot subdivision. In addition, the method includes employing the AI model to analyze the collected data and generate recommendations for the optimal plot boundaries while ensuring compliance with the said state and the municipal regulation and visualizing the recommended plot boundaries, including generating a 3D massing diagram to aid in decision-making by a property owner and/or a developer.

In yet another aspect, a computer-implemented method for optimizing lot subdivision includes acquiring a geospatial property data, a zoning code, a property tax record, and an owner information for a target region. In addition, the method includes fine-tuning an AI model based on the specific state and a municipal regulation governing lot subdivision in the target regio and utilizing the AI model to process and analyze the acquired data, and generating recommendations for an optimal plot boundary that aligns with regulatory compliance and financial viability. Further, the method includes presenting the recommended plot boundaries through a user-friendly interface, including interactive maps and/or a visual representation to facilitate informed decisions by a property owner and/or a developer regarding lot subdivision and property development.

The geospatial property data may include a topographic map, an aerial imagery, and/or property dimensions for comprehensive property analysis. The user-friendly interface may provide a dynamic platform for property owners and/or the developer to interactively explore recommended plot boundaries and adjust parameters to visualize the impact on financial viability and regulatory compliance. The method may further include creating a lot matchmaking service to match available split lots with potential buyers and/or the developer, taking into account the buyers' preferences and the lots' characteristics and developing an automated compliance checklist for the property owner and/or the developer to use in order to ensure every aspect of the lot split meets local regulations before submission.

In addition, the method may include customizing a privacy settings algorithm to suggest lot division based on individual privacy preferences, such as creating natural sound barriers and sightline obstructions. Further, the method may include configuring an energy-efficiency optimizer to suggest lot orientations and divisions to maximize natural light and promote energy-efficient construction practices. Additionally, the method may include utilizing the augmented reality plot visualization to overlay proposed lot split boundaries onto physical land, allowing users to visualize changes in real-time on-site.

Furthermore, the method may include providing an estimate of property taxes for subdivided lots based on the historical tax data and projected valuations using an AI-driven property tax estimator tool. The method may further include translating the lot split data and regulations into different languages to make the system accessible to international markets, and assessing the profitability of developing the split lot, including potential return on investment calculations for different development scenarios using the lot split investment analyzer. The method may additionally include offering regular updates on changes in laws and policies relevant to property the lot split for keeping users informed and prepared for future regulations concerning their property.

The methods and systems disclosed herein may be implemented in any means for achieving various aspects, and may be executed in various forms, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a system interaction view of an AI powered lot subdivision optimization and visualization, using generative AI, according to one embodiment.

FIG. 2 is a map view illustrating a user interface of an AI powered lot subdivision optimization and visualization system of FIG. 1 for generating an optimal plot division recommendation through its comprehensive analysis tools, according to one embodiment.

FIG. 3 is a neighborhood boundary overlay view of the AI powered lot subdivision optimization and visualization system of FIG. 1 illustrating the various search options provided in the zones tab, according to one embodiment.

FIG. 4 is a plot identification view of the AI powered lot subdivision optimization and visualization system of FIG. 1 illustrating automatic determination of valuation of a specific plot based on the user's input data using the search tab, according to one embodiment.

FIG. 5 is a process view illustrating the approach the polygon shape identifier module of the AI powered lot subdivision optimization and visualization system of FIG. 1 may follow in order to optimally divide the particular lot according to the SB9 rules, according to one embodiment.

FIG. 6 is an exploded view illustrating various modules of the AI powered lot subdivision optimization and visualization system of FIG. 1 to propose an optimal division of the plot according to SB9 rules (or similar rule), according to one embodiment.

FIG. 7 is a split lot view illustrating a number of recommended split plot boundaries options generated by the lot splitter module of the AI powered lot subdivision optimization and visualization sytem of FIG. 1 to propose an optimal division of the plot according to SB9 rules (or similar rule), according to one embodiment.

FIG. 8 is a user interface view illustrating an interactive view of the AI powered lot subdivision optimization and visualization sytem of FIG. 1 to provide users with predictions on the future value of the subdivided lots, according to one embodiment.

FIG. 9 is a survey view illustrating the automatic generation of a boundary survey report and a proposed SB9 tentative map by the recommendation engine of the generative AI lot subdivision and visualization system, according to one embodiment.

FIG. 10 is a comparative view of the proposed addition of dwelling units with and without the lot split as per SB9 rules by the recommendation engine of the generative AI lot subdivision and visualization system of FIG. 1, according to one embodiment.

FIG. 11 illustrates the concept of “Generative AI Reshaping the Future,” to transform various aspects of housing supply and municipal regulations using the generative AI lot subdivision and visualization system of FIG. 1, according to one embodiment.

FIG. 12 illustrates the proposed building layout generated by generative AI lot subdivision and visualization system of FIG. 1 after recommendation of lot split using the lot splitter module based on the SB9 zoning rules, according to one embodiment.

FIG. 13 is a process flow detailing the operations involved in generating an optimal plot boundary using the generative AI lot subdivision and visualization system of FIG. 1, according to one embodiment.

Other features of the present embodiments will be apparent from the accompanying drawings and from the detailed description that follows.

### DETAILED DESCRIPTION

Example embodiments, as described below, may be used to provide a method and/or a system to explain a cause of a mistake in a machine learning model using a diagnostics artificial intelligence model.

In one embodiment, a land-use planning system (e.g., AI-powered lot subdivision optimization and visulization system 100) includes a data collection module 112 configured to extract a shape file associated with a property address of a plot of real property in a jurisdiction. The shape file includes a location, a geometry, and attribution of a point, a line, and/or a polygon features of the plot of real property. An AI (artificial intelligence) model 174 (e.g., using deploy and serve model 166 of the data pipeline 104) is adapted (e.g., using adapt model 156 of the data pipeline 104) to analyze the shape file (e.g., using the lot size model hub 122). The AI model is fine-tuned (e.g., using fine-tune model 158 of the data pipeline 104) based on a regulation governing lot subdivision in the jurisdiction (e.g., using municipal regulation and compliance database 126). A recommendation engine 172 is integrated with the AI model to generate an optimal plot boundary 805 suggestion (e.g., using recommendation engine 172 of the data pipeline 104) to adhere to the governmental regulation while maximizing financial viability of split lots from the property address. A visualization component creates a visual representation of the split lots 702 (e.g., using visual representation module 602 of the recommendation engine 172) in the jurisdiction displaying the optimal plot boundary 805 suggestion on a rendering of the shape file.

A data preprocessing component (e.g., using prepare data 128 and data preparation 102 of the data pipeline 104) may be configured to standardize and clean the collected geospatial property information, zoning regulations, property tax records, and owner data using a zoning classification module 606. The AI model's fine-tuning may be continuously updated to accommodate changes in state and municipal regulations (e.g., using municipal regulation and compliance database 126) related to lot subdivision (e.g., using fine-tune model 158 and prediction model 170 of the data pipeline 104). The recommendation engine 172 considers additional factors, including a property age, market trends, and/or a demographic data, when generating the optimal plot boundary 805 suggestions to maximize financial viability. The visualization component (e.g., using visual representation module 602 and 3D massing diagram 1204 generation module 604 of the data pipeline 104) to generate a 3D massing diagram 1204 that adheres to local zoning and planning guidelines, showcasing the proposed lot divisions in a visually compelling manner. The system may include transmitting the recommended the optimal plot boundaries 805 to property owners and developers via electronic communication for review and consideration.

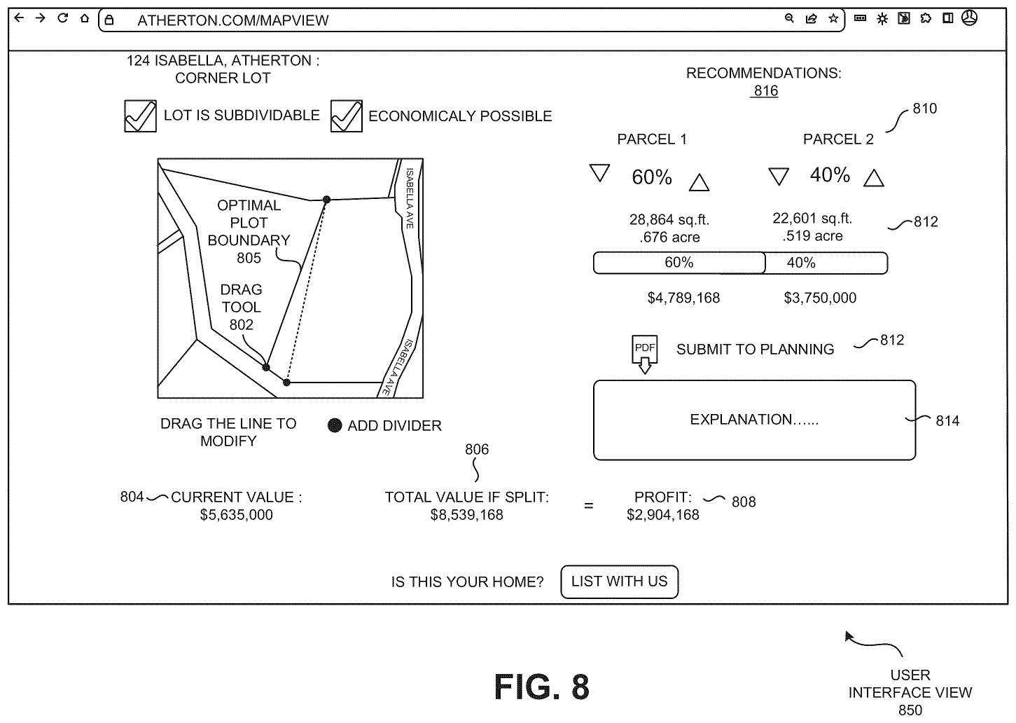

The fine-tuning of the AI model 174 (e.g., using deploy and serve model 166 of the data pipeline 104) may involve adjusting hyperparameters, including learning rates and batch sizes to optimize its performance for the lot subdivision recommendations. The data collection module 112 may use a generative AI model 174 to allow users to input data in a plain language. A user interface of the visualization (e.g., using visual representation module 602 of the recommendation engine 172) component may allow for an interactive query about a plot boundary adjustment and provides a realtime AI-generated feedback (e.g., as shown in FIGS. 8-10). The system may include a feature to generate an executive summary 902 using a generative AI to explain a rationale behind the plot boundary recommendations (e.g., using recommendation engine 172). Further, the system may include an integrated market analysis module 608 to leverage a real-time real estate market data to provide the user with predictions on the future value (e.g., using prediction model 170 of the data pipeline 104) of the subdivided lot for making an informed decision on selling and developing a lot. Furthermore, the system may include a community impact assessment tool to analyze and predict (e.g., using prediction model 170) the impact of the proposed lot split on the local community, including effects on traffic, schools, and public services for presentation to a zoning board and/or a community group.

In addition, the system may include an environmental module 610 implemented using the AI to identify and preserve natural features on the lot, such as trees, water bodies, and topography to ensure that lot subdivision plans are environmentally sustainable. The generative AI may include VR capabilities to allow the user to “walk through” the proposed subdivided lots and surrounding areas, providing a more tangible understanding of the space and its potential. The system may include the generative AI to automatically generate the necessary legal and regulatory documents (e.g., using recommendation engine 172 of data pipeline 104) for submission based on the proposed lot split plan to simplify the process of obtaining approvals, automatically suggest lot split plans that preserve the historical character of the property while still meeting modern development needs based on an AI-driven analysis, and equally led with data to analyze natural disaster data and suggest lot split plans that enhance the resilience of homes and infrastructure to the events such as floods, wildfires, and/or earthquakes.

The system may be integrated with utility mapping and analysis to ensure that subdivided lots optimize the use of existing infrastructure (e.g., using recommendation engine 172 of data pipeline 104), such as water, sewer, and electrical grids, and plan for the efficient placement of new services. The system may utilize a specialized algorithm (e.g., using market analysis module 608 of data pipeline 104) to propose the placement of ADUs on existing lots, considering the potential for a rental income, guest housing, and/or multigenerational living space. The system may suggest negotiation strategies for property owners to use with a neighbor and/or a local authority based on previous successful negotiations and current regulatory environments (e.g., using environmental module 610 of data pipeline 104), and customize an aesthetic algorithm to suggest lot divisions based on aesthetic preferences, incorporating architectural styles, sightlines, and other design elements that align with the character of an existing neighborhood.

In another embodiment, a method for recommending optimal plot boundaries 805 in lot subdivision (e.g., AI-powered lot subdivision optimization and visulization system 100 using data pipeline 104) includes collecting a geospatial property information, a zoning regulation (e.g., using zoning classification module 606 of data pipeline 104), a property tax records, and an owner data. The method includes training an AI model 174 (e.g., using select/train model 132 of the data pipeline 104) to process said geospatial property information. The AI model 174 is fine-tuned (e.g., using fine-tune model 158 of the data pipeline 104) based on a state and a municipal regulation governing (eg., using municipal regulation and compliance database 126) a lot subdivision. In addition, the method includes employing the AI model 174 to analyze the collected data and generate recommendations 816 (e.g., using recommendation engine 172 and prediction model 170 of the data pipeline 104) for the optimal plot boundaries 805 while ensuring compliance with the said state and municipal regulations and visualizing the recommended plot boundaries, including generating a 3D massing diagram 1204 to aid in decision-making by a property owner and/or a developer.

In yet another embodiment, a computer-implemented method for optimizing lot subdivision includes acquiring a geospatial property data, zoning codes, property tax records, and owner information (e.g., using data collection module 112 of the data pipeline 104) for a target region. In addition, the method includes fine-tuning an AI model 174 based on specific state and municipal regulations governing lot subdivision in the target region and utilizing the AI model 174 to process and analyze the acquired data, and generating recommendations 816 (e.g., using recommendation engine 172 and prediction model 170 of the data pipeline 104) for the optimal plot boundary 805 that aligns with regulatory compliance and financial viability. Further, the method includes presenting the recommended plot boundaries 805 through a user-friendly interface (e.g., using user interface view 850 of the data pipeline 104), including interactive maps and/or visual representations (e.g., using visual representation module 602 and 3D massing diagram generation module 604 of the data pipeline 104) to facilitate informed decisions by property owners and/or developers regarding lot subdivision and property development.

The geospatial property data (e.g., using data collection module 112 of the data pipeline 104) may include topographic maps, aerial imagery, and/or property dimensions for comprehensive property analysis. The user-friendly interface (e.g., using user interface view 850 of the data pipeline 104) may provide a dynamic platform for property owners and/or developers to interactively explore recommended plot boundaries (e.g., using recommendation engine 172 of the data pipeline 104) and adjust parameters to visualize the impact on financial viability and regulatory compliance. The method may further include creating a lot matchmaking service to match available split lots 702 with potential buyers and/or developers, taking into account the buyers' preferences and the lots' characteristics and developing an automated compliance checklist for the property owners and/or developers to use in order to ensure every embodiment of the lot split meets local regulations before submission (e.g., using zoning classification module 606 of the data pipeline 104).

In addition, the method may include customizing a privacy settings algorithm (e.g., using safety, privacy, bias and IP safeguards 162 of the data pipeline 104) to suggest lot division based on individual privacy preferences, such as creating natural sound barriers and sightline obstructions. Further, the method includes configuring an energy-efficiency optimizer to suggest lot orientations and divisions to maximize natural light and promote energy-efficient construction practices (e.g., using environmental module 610 of the data pipeline 104). Additionally, the method includes utilizing the augmented reality plot visualization to overlay proposed lot split boundaries onto physical land, allowing users to visualize changes in real-time on-site (e.g., using visual representation module 602 and 3D massing diagram generation module 604 of the data pipeline 104).

Furthermore, the method includes providing estimates of property taxes for subdivided lots based on the historical tax data and projected valuations using an AI-driven property tax estimator tool (e.g., using recommendation engine 172 of the data pipeline 104). The method may further include translating the lot split data and regulations into different languages to make the system accessible to international markets (e.g., using data lake and/or analytics hub 124 of the data pipeline 104), and assessing the profitability of developing the split lot, including potential return on investment calculations for different development scenarios using a lot split investment analyzer (e.g., using recommendation engine 172 of the data pipeline 104). The method may additionally include offering regular updates on changes in laws and policies relevant to property lot split (e.g., using municipal regulation and compliance database 126 of the data pipeline 104) for keeping users informed and prepared for future regulations concerning their property.

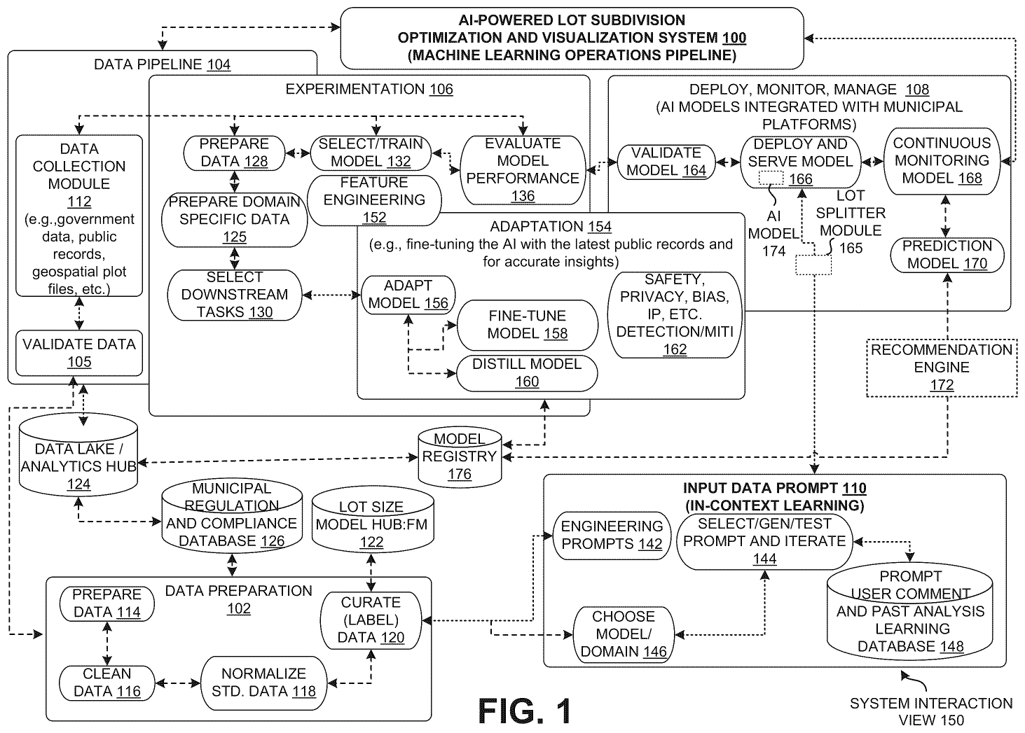

FIG. 1 is a system interaction view 150 of an AI powered lot subdivision optimization and visualization 100, using generative AI, according to one embodiment. FIG. 1 is a visual representation of the complex process of developing and implementing generative AI model 174 in the context of Atherton Studios AI. The life cycle would ensure that the system not only suggests optimal lot divisions but also provides users with economic feasibility insights and the ability to list subdivided lots for sale. FIG. 1 in the document provided represents the Generative AI lifecycle as described in detail on the International Institute for Analytics website. Here's a summary of each element:

Data Pipeline 104: Involves collecting and validating data, which then flows into a data lake and/or analytics hub 124 and feature store for subsequent tasks. Data Pipeline 104 would involve collecting and validating real estate data, zoning laws, and local ordinances relevant to property subdivision, according to one embodiment.

The data pipeline 104 may be a series of steps that transform raw government data into actionable insights for subdividing lots in compliance with complex state and municipal regulations using artificial intelligence techniques. The raw government data may encompass public records, geospatial plot files, assessor information, zoning details, state legal codes, and municipal regulations, etc. that may be utilized to create generative AI models for automating the lot subdivision followed by suggesting the optimal plot boundary.

The generative AI models for automating the lot subdivision of the disclosed system may include the process of collecting, processing, and transforming raw government data into a format that can be used to train and deploy machine learning models. A lot subdivision AI model 174 related to urban planning and development may include various stages such as collecting the real estate data (e.g., using data collection module 112), verifying the data (e.g., using validate data 105), preprocessing the data for removing the errors in the data (e.g., using prepare data 128), extracting valuable information from the data for the AI model (e.g., using prepare domain specific data 125), labeling the data based on whether they are suitable for subdivision according to SB9 rules (and/or similar statutes), using the preprocessed and labeled data to train the AI model 174 (e.g., using select/train model 132), assessing the performance of the trained model using validation datasets (e.g., using evaluate model performance 136 of experimentation 106), and integrating the trained model into a system and/or an application that can make predictions on new lots (e.g., using deploy and serve model 166 and prediction model 170).

The AI-powered lot subdivision optimization and visulization system 100 may use data collection module 112 to collect data from external sources such as public records (e.g., zoning regulation, land ownership, etc.), GIS data (e.g., topographical data), and/or market data (e.g., real estate sales data, demographics, etc.). The system may further receive data from internal sources such as existing subdivision plans, developer and planner knowledge, and customer feedback relevant to the disclosed lot subdivision AI module.

The AI-powered lot subdivision optimization and visulization system 100 may be ingested with data collected from external and internal sources (e.g., using data lake and/or analytics hub 124) including the geographical information, land use records, zoning regulations, environmental data, and any other relevant information related to the real property. The system may further acquire satellite imagery, maps, and/or other geospatial data that can provide a detailed view of the area. The system may automatically identify a shape file, and consult the relevant data, including property dimensions, current zoning information, and any specific regulatory requirements applicable to the location of the identified real property. The system may gather a diverse and representative dataset of intricate landscape from municipal regulation and compliance database 126 including the local zoning codes, zoning maps, land use regulations, state and municipal regulations, accessibility, setback requirements, privacy considerations, and desirability of resulting home constructions. etc. that reflects the characteristics of the task the AI powered lot subdivision generative model is designed for (e.g., using prediction model 170 from deploy, monitor, manage 108). The collected data may include the spatial shape files containing precise geometric information about plots, neighborhood boundaries, and corresponding municipal zones. Property tax records may also be obtained, providing insights into property values, tax assessments, and historical tax payment records. Year-built data may include details about property age, while owner information may facilitate legal and communication aspects.

The system may ensure that the dataset covers a wide range of scenarios, variations, and potential inputs that the model may encounter such as ingress and egress options, setback regulations, privacy concerns, the desirability of potential homes, and any specific regulatory requirements applicable to location, etc. The system may validate data 105 to check for missing values and inconsistencies in the data collected from the internal and external sources in order to ensure that the data quality meets the AI model requirements (e.g., using data preparation 102).

Experimentation 106: This phase includes preparing data, engineering features, selecting and training models, adapting the model, and evaluating the model's performance. Experimentation 106 would encompass the AI analyzing different subdivision scenarios against the collected data to suggest the best ways to split a lot.

The experimentation 106 phase of the data pipeline 104 of the AI-powered lot subdivision optimization and visulization system 100 may include prepare data 128 for feature engineering 152, extracting and/or preparing domain specific data 125, and selecting downstream task 130. The feature engineering 152 may be the manipulation—addition, deletion, combination, mutation—of the collected data set to improve machine learning model training, leading to better performance and greater accuracy. The feature engineering 152 may help extract relevant features from the collected data using the data collection module 112 (e.g., lot size, proximity to amenities, physical size of primary home, frontage, etc.) from a lot size data. It may further expand the dataset through data augmentation by artificially increasing the training set to create modified copies of a dataset from existing data to improve model performance. The preparing domain specific data 125 may include domain-specific knowledge and/or constraints (e.g., zoning requirements, environmental regulations, etc.) for a particular geographical area derived from the municipal regulation and compliance database 126. The feature engineering 152 may be the design features that capture the relevant information for the chosen downstream task and may select features that are informative and robust to noise. The select downstream task 130 may define the specific task a model will perform. For example, the select downstream task 130 may define the task of generating the lot layouts for a specific AI model 174 in the data pipeline 104. In another example embodiment, the select downstream task 130 may define the task of identifying optimal lot sizes, etc. for a particular AI model 174 in the data pipeline 104. The feature engineering 152 may be the process of extracting features from raw data received through the data collection module 112 to support training a downstream statistical model. The process may select and transform variables when creating a predictive model 170 using machine learning for solving a problem received by the AI-powered lot subdivision optimization and visulization system 100. The select/train model 132 in the experimentation 106 phase may choose an appropriate AI generative language model for a particular task by considering factors like task complexity, lot data size, and/or computational resources, etc. In the next step of experimentation 106 phase, the model may be trained on a portion of data to evaluate the model's performance 136 on a separate test set. The test results may be analyzed to identify areas of improvements to improve model's performance.

In the adaptation 154 phase, the machine learning models may adapt and improve their performance as they are exposed to more data by fine tuning (e.g., using the fine-tune model 158) the adapt model 156 for a specific lot subdivision domain and include additional domain specific knowledge. The adapt model 156 may modify the model architecture to better handle a specific task. The fine-tune model 158 may train the model on a curated dataset of high-quality data by optimizing the hyperparameters to improve model performance. The distill model 160 may simplify the model architecture to reduce computational cost by maintaining and improving model performance. The system may implement safety, privacy, bias and IP safeguards 162 to prevent bias and discrimination while predicting a lot size subdivision according to the SB9 rules. The system may ensure model outputs are fair and transparent while protecting the sensitive data as well.

The data preparation 102 may be the process of preparing raw geographical and real property data extracted from the data lake and/or analytics hub 124 based on the prompt received from a user so that it is suitable for further processing and analysis by the AI-powered lot subdivision optimization and visulization system 100. The data preparation 102 may include collecting, cleaning, and labeling raw data into a form suitable for machine learning (ML) algorithms and then exploring and visualizing the data. The data preparation 102 phase may include prepare data 114, clean data 116, normalize standardized data 118, and curate data 120. The prepare data 114 may involve preprocessing the input data (e.g., received using the data collection module 112) by focussing on the data that is needed to design and generate a specific data that can be utilized to guide data preparation 102. The prepare data 114 may further include conducting geospatial analysis to assess the physical attributes of each plot, zoning regulations, and neighborhood delineations, etc. In addition, the prepare data 114 may include converting text to numerical embeddings and/or resizing images for further processing.

The clean data 116 may include cleaning and filtering the data to remove errors, outliers, or irrelevant information from the collected data. The clean data 116 process may remove any irrelevant and/or noisy data that may hinder the AI-powered lot subdivision optimization and visulization system 100.

The normalize standardized data 118 may be the process of reorganizing data within a database (e.g., using the data lake and/or analytics hub 124) of the AI-powered lot subdivision optimization and visulization system 100 so that the AI model 174 can utilize it for generating and/or address further queries and analysis. The normalize standardized data 118 may the process of developing clean data from the collected data (e.g., using the collect data module 112) received by the database (e.g., using the data lake and/or analytics hub 124) of the AI-powered lot subdivision optimization and visulization system 100. This may include eliminating redundant and unstructured data and making the data appear similar across all records and fields in the database (e.g., data lake and/or analytics hub 124). The normalize standardized data 118 may include formatting the collected data to make it compatible with the AI model of the AI-powered lot subdivision optimization and visulization system 100.

The curate data 120 may be the process of creating, organizing and maintaining the data sets created by the normalize standardized data 118 process so they can be accessed and used by people looking for information. It may involve collecting, structuring, indexing and cataloging data for users of the AI-powered lot subdivision optimization and visulization system 100. The curate data 120 may clean and organize data through filtering, transformation, integration and labeling of data for supervised learning of the AI model 174. Each lot in the AI-powered lot subdivision optimization and visulization system 100 may be labeled based on whether they are suitable for subdivision according to SB9 rules. The normalize standardized data 118 may be labeled based on the lot size model hub 122 and input data prompt 110 of the real property database (e.g., using municipal regulation and compliance database 126).

The data lake and/or analytics hub 124 may be a repository to store and manage all the data related to the AI-powered lot subdivision optimization and visulization system 100. The data lake and/or analytics hub 124 may receive and integrate data from various sources in the network to enable data analysis and exploration for lot subdivision optimization and visualization.

Maturity Level 1: Prompt, In-Context Learning, and Chaining: At this stage, a model is selected and prompted to perform a task. The responses are assessed and the model is re-prompted if necessary. In-context learning (ICL) allows the model to learn from a few examples without changing its weights. Prompt and In-Context Learning would involve prompting the AI with specific lot information and learning from past successful subdivisions to improve suggestions.

Input data prompt 110 may be a process of engineering input prompts for AI-powered lot subdivision optimization and visulization system 100. Input data prompt 110 may be the process of structuring text that can be interpreted and understood by a generative AI model. The engineering prompts 142 may create clear and concise prompts that guide the model towards generating desired outputs. The engineering prompts 142 may include relevant context and constraints in the prompts. The engineering prompts 142 may help choose model domain that may specify the domain of knowledge the model should utilize during generation and ensures that the model is trained on data relevant to the target domain. For example, the engineering prompts 142 may create prompts based on certain regulations such as splitting proportion of the lot size, home's rental history, exterior wall alteration rules, demolition rules, etc. for a particular jurisdiction.

The engineering prompts 142 may further include example database that provides examples of desired output to guide the model. The example database may include examples of lot layouts, designs, and/or visualizations of the real property based on SB9 rules. The engineering prompts 142 may include specifically crafted prompts that effectively convey the desired task and/or questions that encourages a coherent, accurate, and relevant response from the AI model 174.

A prompt may be natural language text describing the task that an AI model for lot subdivision and visualization system should perform. Prompt engineering may serve as the initial input to the curate data 120. It may encapsulate the requirements, objectives, and constraints related to lot subdivision within a real property. Input data prompt 110 may be formulated based on various factors such as land characteristics, zoning regulations, and other relevant parameters. It may initiate the optimization and visualization process, guiding the AI system on the specific goals and considerations for lot subdivisions. Before starting with data preparation, it's essential to define the problem the user wants the AI model 174 to solve. During this stage, the user may identify the specific tasks or instructions the model of the AI powered lot subdivision optimization and visualization system 100 should be capable of handling. This helps set the stage for designing appropriate prompts and planning for potential tuning strategies later on.

Select/generate/test prompt and iterate 144 may be the process that involves the iterative process of selecting, generating, and testing prompts. AI-powered lot subdivision optimization and visulization system 100 may refine the prompt engineering through successive iterations, adjusting parameters and criteria to enhance the optimization results. This iterative loop may be essential for fine-tuning the AI algorithms, ensuring that the system adapts and improves its performance based on feedback and testing.

Choose model/domain 146 may be the process of selecting an appropriate AI model and/or domain for the lot subdivision optimization task. Different models may be employed based on the complexity of the real property, regulatory framework, and/or specific project requirements. The choice of model/domain influences the system's ability to analyze and generate optimized lot subdivision solutions tailored to the given context.

The prompt user comment and past analysis learning database 148 may be a repository of user queries and/or inputs that are used for training and/or testing the AI mode to elicit a specific response and/or output for the lot subdivision optimization. The prompt user comment and past analysis learning database 148 may be iteratively modified based on the user interaction and analysis of past learning models.

Chain it: This involves a sequence of tasks starting from data extraction, running predictive models, and then using the results to prompt a generative AI model to produce an output. Chain it would mean applying predictive analytics to real estate market data to inform subdivision decisions.

Tune it: Refers to fine-tuning the model to improve its responses. This includes parameter-efficient techniques and domain-specific tuning. Tune it would involve fine-tuning the AI with local real estate trends and specific subdivision constraints for accurate estimations.

Deploy, Monitor, Manage 108: After a model is validated, it is deployed, and then its performance is continuously monitored. Deployment would see the AI being integrated into the Atherton.com platform, where it would be monitored and managed as users interact with it for lot subdivision suggestions. In this phase, a model is validated before deployment. The validate model 164 may be a set of processes and activities designed to ensure that an ML or an AI model performs a designated task, including its design objectives and utility for the end user. The validate model 164 may perform final testing to ensure model readiness for deployment and address any remaining issues identified during testing. The validate model 164 may evaluate the trained model's performance on unseen data. For example, the unseen data may include data from a new neighborhood that is currently under development, data from a demographic group that is not well-represented in the training data, data from a hypothetical scenario, such as a proposed zoning change. And/or/Land Use, Zoning, environmental factors, reflecting diverse demographics, locations, and socio-economic backgrounds. SB9 emphasizes preventing discriminatory practices in land use and zoning. Unseen data such as land use, zoning, environmental factors, reflecting diverse demographics, locations, and socio-economic backgrounds may help in identifying potential biases in the model's predictions, such as favoring certain types of housing and/or developers over others. This may be done by analyzing the trained model's performance on data from diverse neighborhoods and ensuring it does not perpetuate historical biases in housing access. Validate model 164 may be evaluated for potential bias in land use and zoning decisions, promoting equitable development and avoiding discriminatory patterns the fair and transparent valuations across different demographics and locations, ensuring it may be generalized well and produce accurate predictions in real-world scenarios. Validate model 164 may help in identify potential biases in the model's training data and/or its decision-making process, promoting fairness and ethical AI development. By identifying areas where the train model may be improved, validate model 164 may help to optimize its performance and efficiency, leading to better resource utilization and scalability. Once the final fine-tune model 158 is validated, it may be put to the test with data to assess its real-world effectiveness. Subsequently, it can be deployed for practical use within the AI-powered lot subdivision optimization and visulization system 100.

The deploy and serve model 166 may include deploying the trained model after validating through the validate model 164 to the endpoint, testing the endpoint, and monitoring its performance. Monitoring real-time data may identify changes in property values, zoning regulations, and market conditions, and updating the AI model's fine-tuning accordingly. The model's performance may be continuously monitored using the continuous monitoring model 168, and additional fine-tuning may be executed as needed to adapt to evolving regulations and shifting market conditions by using the fine-tune model 158. Continuous monitoring model 168 may provide perpetual monitoring for optimum performance of model. The prediction model 170 may be a program that detect specific patterns using a collection of data sets. The prediction model 170 may make predictions, recommendations and decisions using various AI and machine learning (ML) techniques of the AI-powered lot subdivision optimization and visulization system 100. Predictive modeling may be a mathematical process used to predict future events or outcomes by analyzing patterns in a given set of input data. A model registry 176 may be a centralized repository for storing, managing, and tracking the different versions of the machine learning models of the AI-powered lot subdivision optimization and visulization system 100. The model registry 176 may acts as a single source of truth for all model artifacts, including model code and weights, metadata like training parameters, performance metrics, and author information versions and timestamps documentation and note. The prediction model 170 may involve much more than just creating the model itself. encompassing validation, deployment, continuous monitoring, and maintaining the model registry 176.

Maturity Level 3: RAG it & Ground it: Retrieval Augmented Generation (RAG) is used to provide context for the model by retrieving relevant information from a knowledge base. Grounding ensures the model's outputs are factually accurate. RAG and Grounding would be utilized to provide contextually relevant information from real estate databases to ensure recommendations are grounded in factual, up-to-date property and market data.

FLARE it: A proactive variation of RAG that anticipates future content and retrieves relevant information accordingly. FLARE it would predict future changes in zoning laws or market conditions that could affect subdivision potential.

CoT it or ToT it. GoT it?: These are frameworks for guiding the reasoning process of language models, either through a Chain of Thought, Tree of Thought, or Graph of Thought, allowing for non-linear and interconnected reasoning. CoT, ToT, GoT frameworks would guide the AI's reasoning process as it considers complex subdivision scenarios, ensuring it can explore multiple outcomes and provide well-reasoned subdivision suggestions.

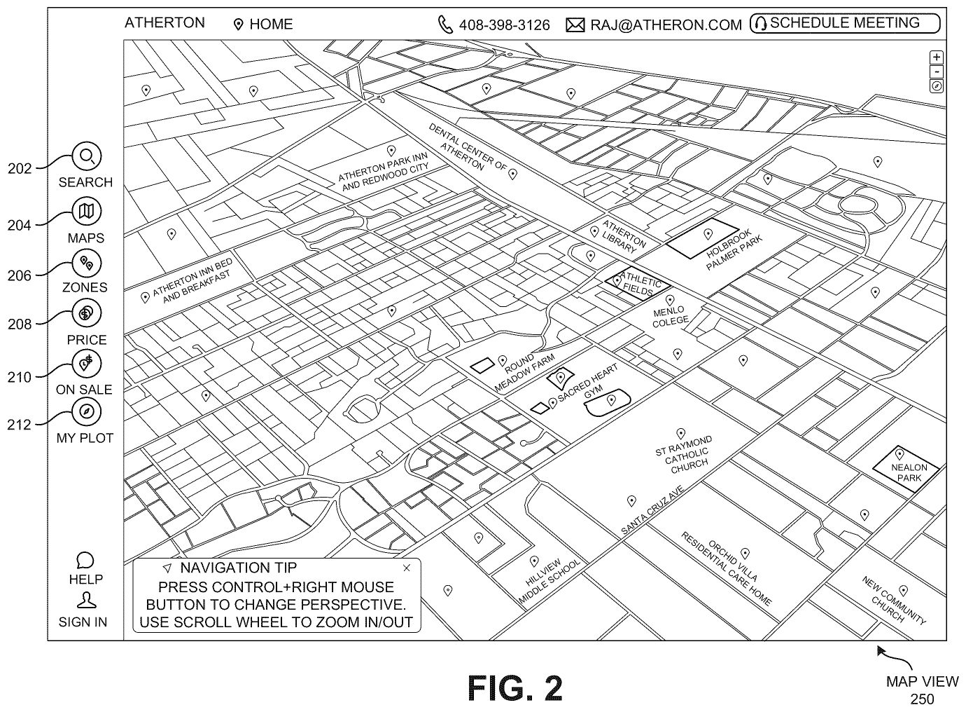

FIG. 2 is a map view 250 illustrating a user interface of an AI-powered lot subdivision optimization and visulization system 100 of FIG. 1 for generating an optimal plot division recommendation through its comprehensive analysis tools. Particularly, FIG. 2 illustrates various search tools provided in its command bar to enable a user to interact with its database in realtime. The AI-powered lot subdivision optimization and visulization system 100 may automatically present a user with various interactive implementations of the embodiments described in the data pipeline 104 of the system. For example, the command bar of the AI-powered lot subdivision optimization and visulization system 100 may include a search 202 tab, a maps 204 tab, a zones 206 tab, a price 208 tab, an on sale 210 tab, and a my plot 212 tab, according to one embodiment. The search 202 tab may allow a user to search for a plot by an area name and/or an area code. The maps 204 tab may generate a satellite and/or a topographical map of the neighborhood area for a particular plot using its data lake and/or analytics hub 124 integrated with the municipal regulation and compliance database 126. The zones 206 tab may provide zoning information for a particular plot and/or address based on the neighborhoods, pricing category and availability for a sale, purchase and/or lease in a particular zone, according to the SB9 rules. The on sale 210 tab may auto-populate the real plot numbers that may be up for sale and/or purchase. The user may receive latest information related to the regulatory compliance for his plot and/or update it in the AI-powered lot subdivision optimization and visulization system 100 using the my plot 212 tab.

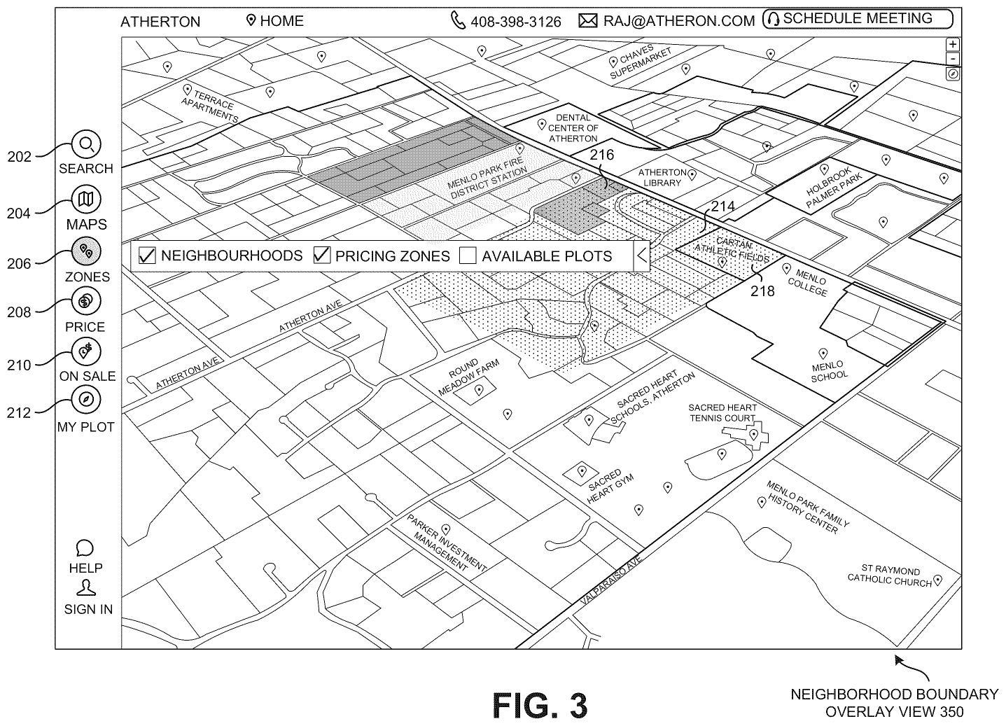

FIG. 3 is a neighborhood boundary overlay view 350 of the AI-powered lot subdivision optimization and visulization system 100 of FIG. 1 illustrating the various search options provided in the zones 206 tab. Once a user selects the zones 206 tab, the user may be provided with three options such as neighbourhoods, pricing zones, and available plots. The ‘neighborhood’ popup tab may distinguishingly identify the plots in the region surrounding a particular plot. The ‘pricing zones’ popup tab may distinguishingly highlight the plots in the region to identify similarly priced plots. The ‘available plots’ popup tab may distinguishingly highlight the plots available for sale, purchase, and/or rent in the region, according to one embodiment. For example, highlighted portion 214 in FIG. 3 may distinguishingly identify the plots in the neighborhood region of a particular plot boundary ‘cartan athletic fields’ 218 while highlighted portion 216 may display an overlay of similarly priced plots in the neighborhood region of the particular plot boundary ‘cartan athletic fields’ 218, according to one embodiment.

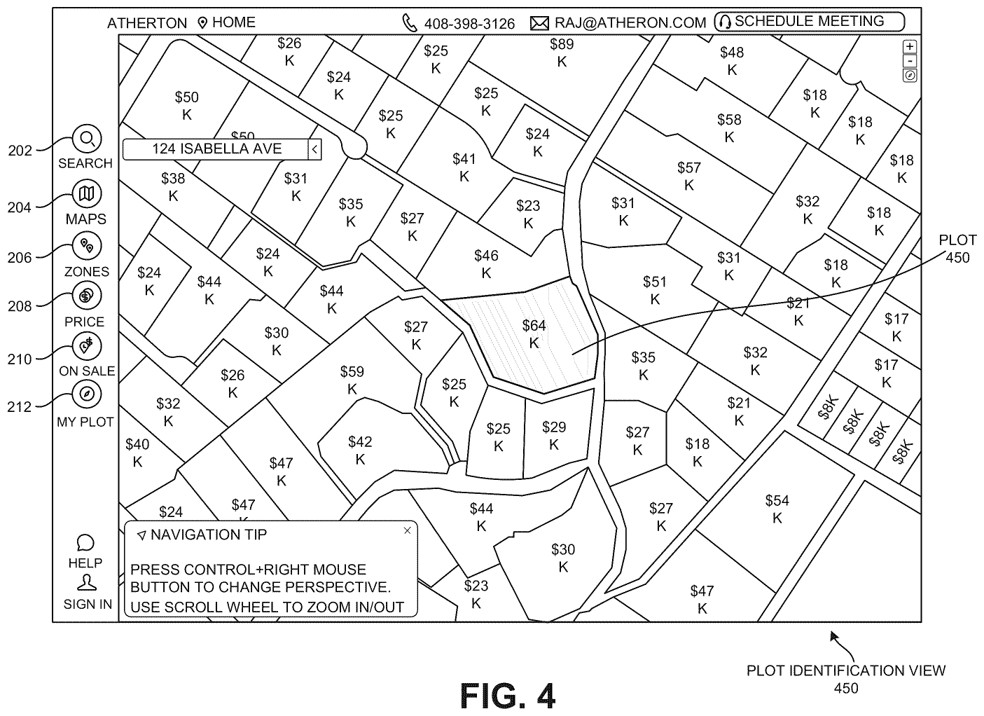

FIG. 4 is a plot identification view 450 of the AI-powered lot subdivision optimization and visulization system 100 of FIG. 1 illustrating automatic determination of valuation of a specific plot based on the user's input data using the search 202 tab. The user may only need to enter an address (e.g., data lake and/or analytics hub 124 Isabella Ave.) and/or plot number of a particular plot in the search 202 tab. The plot identifier module 612 of the AI-powered lot subdivision optimization and visulization system 100 may automatically identify the lot 450 as the specific address and display its location in the map by highlighting it. Further, the plot identifier module 612 may also display the current value of the plot through its interface.

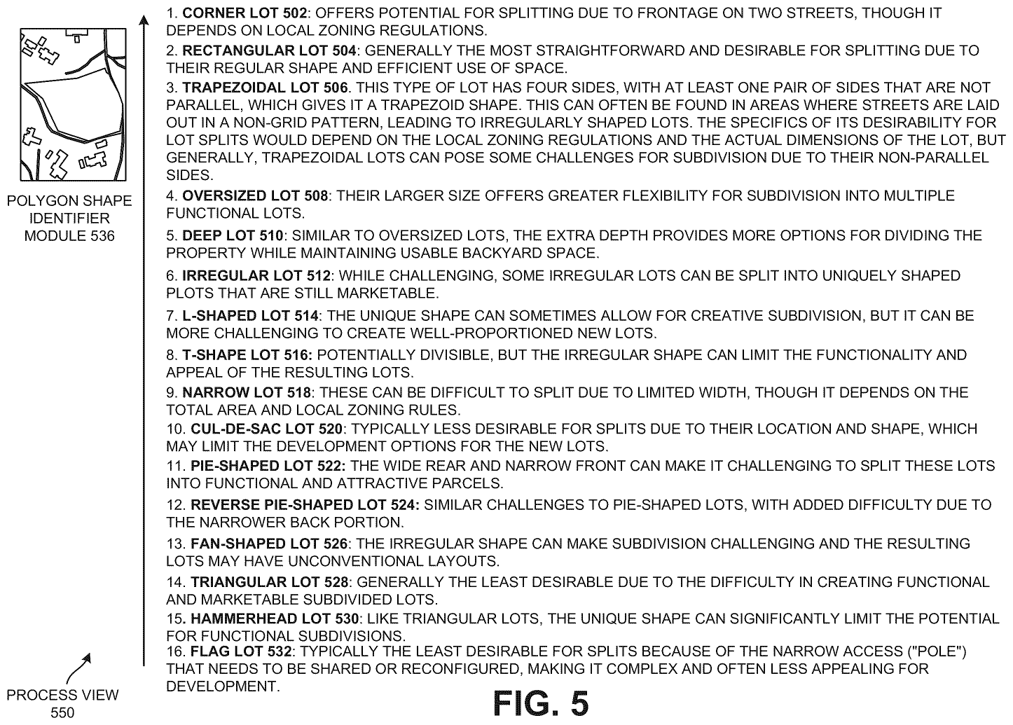

FIG. 5 is a process view 550 illustrating the approach the polygon shape identifier module 434 of the AI-powered lot subdivision optimization and visulization system 100 of FIG. 1 may follow in order to optimally divide the particular lot 450 according to the SB9 rules. For example, for a corner lot 502, the polygon shape identifier module 436 may evaluate the potential for splitting the lot 450 based on frontage on two streets by considering local zoning regulations regarding access and setback requirements, identifying optimal split lines that maximize both street frontages. For a rectangular lot 504, the polygon shape identifier module 434 may efficiently calculate the division of space, ensuring each new lot complies with size and frontage requirements. The polygon shape identifier module 434 may identify the most marketable and functional subdivision of the layout. For a trapezoidal lot 506, the polygon shape identifier module 434 may assess how the non-parallel sides impact potential subdivisions. It may use geometric algorithms to find the best division lines that meet zoning requirements and maintain functional lot shapes.

For an oversized lot 508, the polygon shape identifier module 434 may analyze different subdivision scenarios given its oversize shape. It may optimize the split to create multiple functional lots while considering existing structures and the potential for maximized land use.

For a deep lot 510, the polygon shape identifier module 434 may examine the depth to provide options for dividing the property. The extra depth may provide more options for dividing the property while maintaining the usable backyard space.

For an irregular lot 512, the polygon shape identifier module 434 may run multiple subdivision simulations to find viable configurations. It may considers unique angles and dimensions to create marketable and compliant subdivided plots.

For an L-Shaped lot 514, the polygon shape identifier module 434 may navigate the challenges of this shape by exploring creative subdivision solutions. It may ensure that each new lot has functional space and adheres to zoning regulations.

For a T-Shape lot 516, the polygon shape identifier module 434 may evaluate the limited functionality and appeal of potential subdivisions. It may seek to maximize the usability of each section while adhering to setback and area requirements.

For a narrow lot 518, the polygon shape identifier module 434 may assess for total area and width. The polygon shape identifier module 434 may determine if a viable split is possible without compromising the functionality of each new lot and adhering to minimum width requirements.

For a Cul-de-Sac lot 520, the polygon shape identifier module 434 may evaluate the limited development options due to the location and shape. It may considers local market preferences and zoning limitations in assessing subdivision feasibility.

For a pie-shaped lot 522, the polygon shape identifier module 434 may analyze how to divide the wide rear and narrow front in a manner that creates functional and attractive parcels, considering the unique challenges of this shape.

For a reverse pie-shaped lot 524, the polygon shape identifier module 434 may explore ways to maximize the usability of the narrower section.

For a fan-shaped lot 526, the polygon shape identifier module 434 may tackle the irregular shape to find subdivision solutions, aiming to create lots with functional layouts despite unconventional dimensions.

For a triangular lot 528, the polygon shape identifier module 434 may determine if a functional and marketable subdivision is possible, often focusing on maximizing the utility of the broader section.

For a hammerhead lot 530, the polygon shape identifier module 434 may assesses the unique shape to find potential subdivision lines, though the options may be limited due to the unconventional layout.

For a flag lot 532, the polygon shape identifier module 434 may evaluate the complexities of sharing or reconfiguring the access. It may assess whether a subdivision is feasible without compromising the functionality and appeal of the lots.

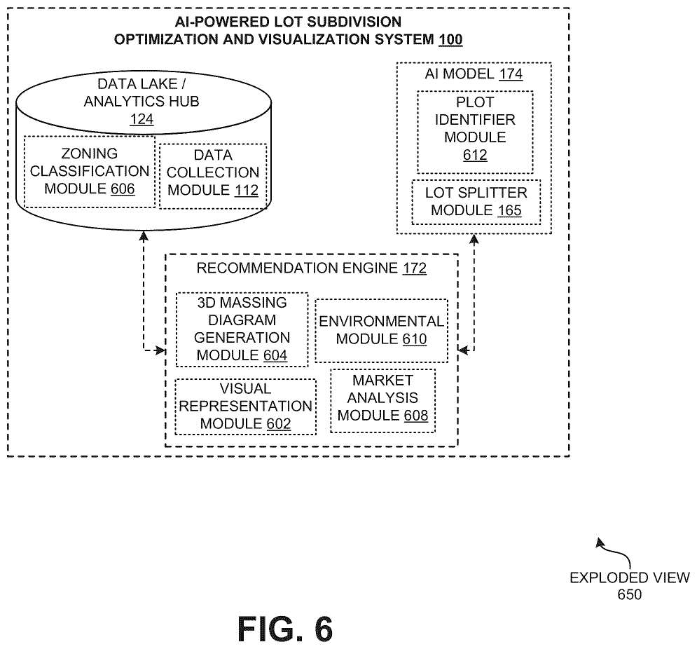

FIG. 6 is an exploded view 650 illustrating various modules of the AI-powered lot subdivision optimization and visulization system 100 of FIG. 1 to propose an optimal division of the plot 450 according to SB9 rules (or similar rule). Particularly, FIG. 6 builds on FIGS. 1-5, and further adds, a visual representation module 602, 3D massing diagram generation module 604, zoning classification module 606, market analysis module 608, environment module 610, and plot identifier module 612, according to one embodiment.

The visual representation module 602 may be a software component designed to convert complex property data into visually intuitive representation. The visual representation module 602 may include rendering features to create 3D massing diagrams 1204. The module may allow users to visualize and comprehend proposed lot division in a detail and visually compelling manner. The rendering technology may be used to provide a realistic depiction of the subdivided lots in relation to existing structures, topography, and natural features.

The 3D massing diagram generation module 604 may be a software tool that transforms property data into three-dimensional massing diagrams. The 3D massing diagram generation module 604 may be integrated with the visual representation module 602. The 3D massing diagram generation module 604 may use geospatial and property data to automatically generate accurate 3D massing diagram 1204 that comply to local zoning and planning guidelines. The 3D massing diagram generation module 604 may consider various factors, including plot boundaries, building heights, setbacks, and architectural styles, ensuring that the proposed lot divisions align with regulatory requirements and aesthetic preferences to generate the massing diagram to propose an optimal division of the plot according to SB9 rules (or similar rule) maximizing both compliance and desirability.

The zoning classification module 606 may be an integral part of the AI-powered lot subdivision optimization and visulization system 100. The zoning classification module 606 may serve as a robust data preprocessing component, standardizing and cleaning geospatial property information, zoning regulations, property tax records, and owner data. This module may employ algorithms to classify and categorize properties based on zoning regulations. The market analysis module 608 may be a data driven component of recommendation engine 172. The market analysis module 608 may provide real-time real estate market data. The market analysis module 608 may provide user with prediction on the future value of subdivided lots, enabling informed choices regarding selling and/or developing properties. The AI-driven technology of the data pipeline 104 described herein may consider variables such as property age, market trends, and demographic data to generate accurate and reliable market analysis tailored to specific jurisdiction.

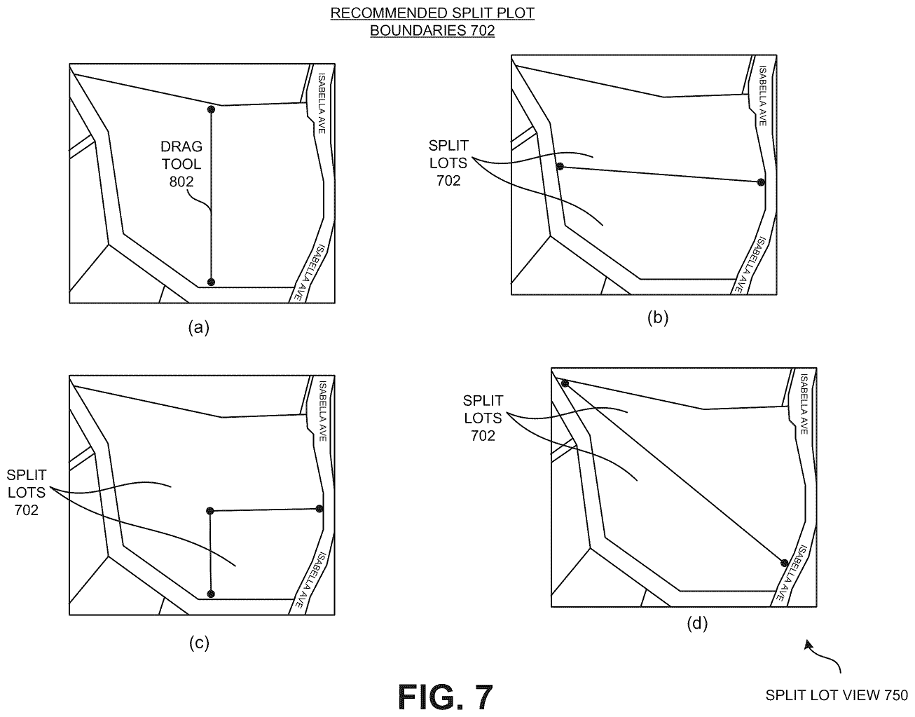

FIG. 7 is a split lot view 750 illustrating a number of recommended split plot boundaries 702 options generated by the lot splitter module 165 of the AI-powered lot subdivision optimization and visulization system 100 of FIG. 1 to propose an optimal division of the plot 450 according to SB9 rules (or similar rule). The lot splitter module 165 of the AI-powered lot subdivision optimization and visulization system 100 may comprehensively analyze a multitude of factors including state and municipal regulations, accessibility, setback requirements, privacy considerations, and desirability of resulting home constructions. By processing this information, the system may identify the perfect location for subdividing a lot that maximizes both compliance and desirability. The lot splitter module 165 may offer a holistic view that enables it to pinpoint the perfect location for lot subdivision, ensuring not only regulatory compliance but also the highest desirability and functionality of the resulting lots. For example, as shown in option (a), the lot splitter module 165 may divide the plot in two equal sizes considering the local zoning regulations regarding access and setback requirements such that both lot sizes have ingress and egress options according to zoning regulations for each of the proposed building construction layout. In option (b), the lot splitter module 165 may divide the lot consisdering factors such as setback regulations, privacy concerns, etc. In option (c), the lot splitter module 165 may divide the lot in two, one with larger size unit and other of smaller size additional dwelling unit considering the potential for a rental income, guest housing, and/or multigenerational living space. In option (d), the lot splitter module 165 may divide the lot diagonally to maximize the street frontages for the subdivided lots, according to one embodiment.

FIG. 8 is a user interface view 850 illustrating an interactive view of the AI-powered lot subdivision optimization and visulization system 100 of FIG. 1 to provide users with predictions on the future value of the subdivided lots. The UX view in FIG. 8 presents an interactive and informative interface for a user considering subdividing their property, specifically a corner lot located at “2 Lowery, Atherton, CA.” Here's a detailed description of the interface: The top of the view clearly identifies the address and type of lot (Corner Lot). The interface provides straightforward indicators that the lot is subdividable and that subdivision is economically feasible. It displays a recommendation for splitting the lot into two parcels (Parcel 1 and Parcel 2) with a suggested division of 60% for Parcel 1 and 40% for Parcel 2. For each parcel, the interface shows the size in square feet and acres. It also indicates the estimated value of each parcel after subdivision. Parcel 1: 28,864 sq. ft. (0.676 acre), estimated value $4,789,168. Parcel 2: 22,601 sq. ft. (0.519 acre), estimated value $3,750,000.

A notable feature of FIG. 8 is the “Drag the line to modify” option using the drag tool 802, allowing users to interactively adjust the subdivision line between the parcels 810, thus altering the percentage split and recalculating the values dynamically. The current value 804 of the entire lot is displayed ($5,635,000), along with the total value if split 806 ($8,539,168), highlighting the potential profit 808 from subdividing the lot ($2,904,168). There's an option to “Submit to planning” 812 facilitating the process of taking the next steps in the subdivision process The interface also prompts, “Is this your home? List with us,” indicating a seamless transition to listing the property for sale through the platform. The layout is clear and user-friendly, with a focus on providing essential information in a straightforward manner. The use of visual elements like indicators and interactive sliders enhances the user experience. This UX design effectively combines informational display, interactive elements, and clear call-to-action prompts, making the process of understanding and initiating property subdivision accessible and appealing to property owners, according to one embodiment.

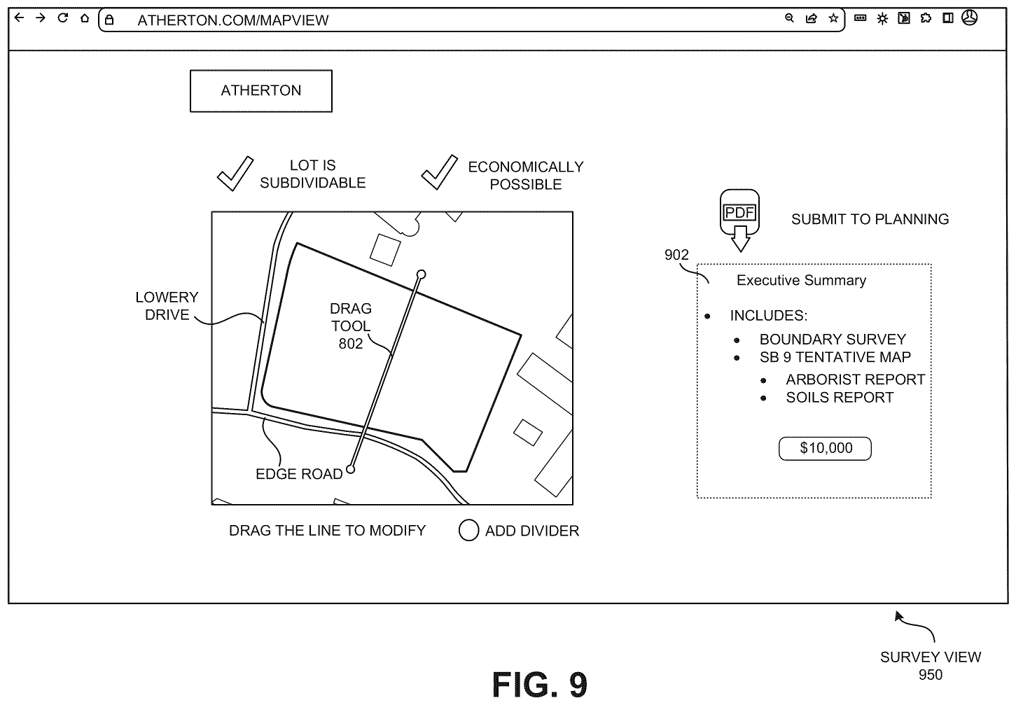

FIG. 9 is a survey view 950 illustrating the automatic generation of a boundary survey report and a proposed SB9 tentative map by the recommendation engine 172 of the generative AI-powered lot subdivision optimization and visulization system 100, according to one embodiment. As shown in the figure, the recommendation engine 172 may craft an executive summary 902 that succinctly and intelligibly explains the rationale behind its specific plot boundary recommendation. This executive summary 902 may serve as a valuable resource for homeowners, developers, and regulatory authorities, offering a clear, concise, and transparent account of the AI's decision-making process.

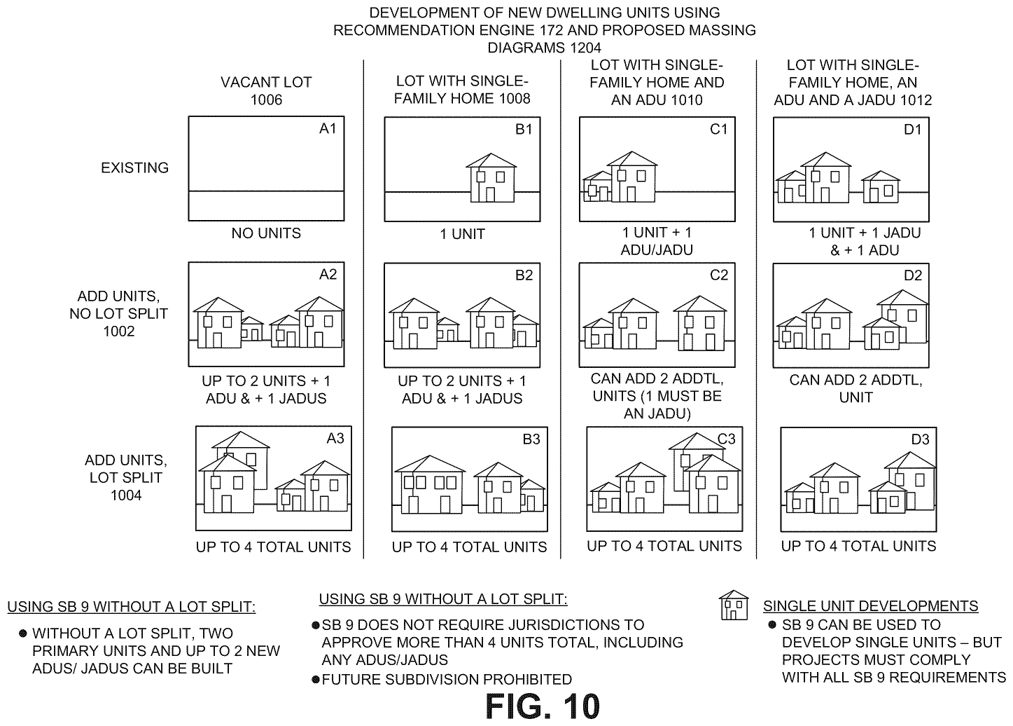

FIG. 10 is a comparative view 1050 of the proposed addition of dwelling units with and without the lot split as per SB9 rules by the recommendation engine 172 of the generative AI-powered lot subdivision optimization and visulization system 100, according to one embodiment. As shown in the Figure, the generative AI of the recommendation engine 172 may automatically generate the proposed development of new dwelling in various types of lots with lot split using the lot splitter module 165 of the AI-powered lot subdivision optimization and visulization system 100 as per SB9 rules. For example, a vacant lot 1006, upto 4 total units may be added with a lot split 1004 using the generative AI of the recommendation engine 172 as compared to 2 units with one ADU and 1 JADU with no lot split 1002. For a lot with single family home 1008, upto 4 total units may be added with a lot split 1004 as recommended by the generative AI of the recommendation engine 172 as compared to 2 units with one ADU and 1 JADU with no lot split 1002. For a lot with single family home and an ADU 1010, upto 4 total units may be added with a lot split 1004 compared to 2 additional units of which one must be JADU with no lot split 1002. For a lot with single family home, an ADU and a JADU 1012, upto 4 total units may be added with a lot split 1004 compared to just additional unit with no lot split 1002, making a economically viable and profitable housing solution for the user, according to one embodiment.

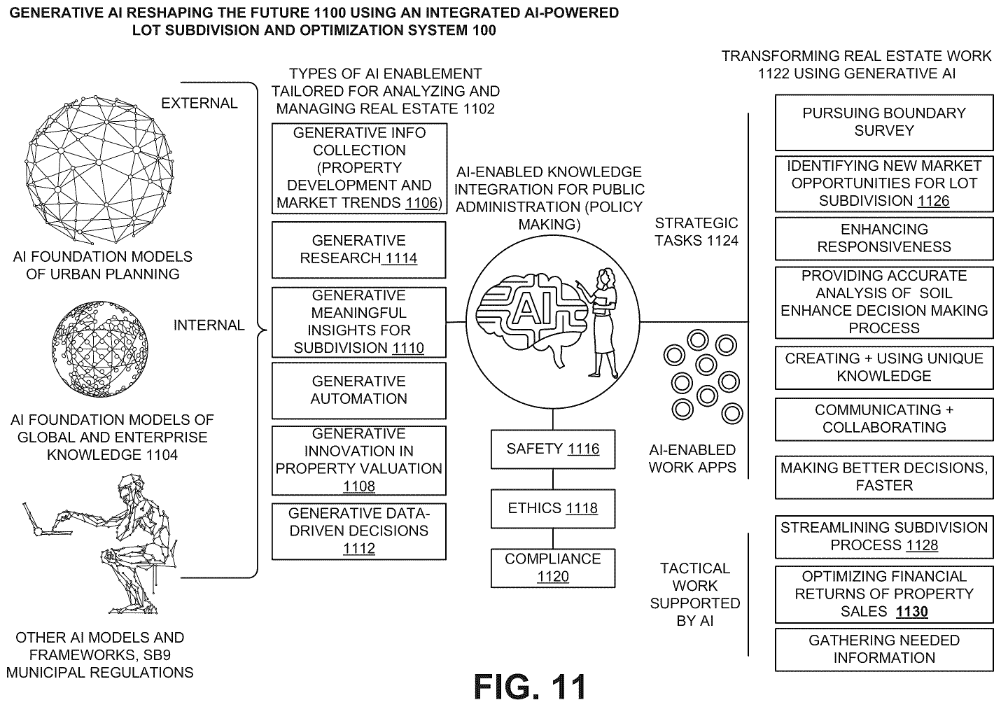

FIG. 11 illustrates the concept of “Generative AI Reshaping the Future 1100,” according to one embodiment. It showcases how artificial intelligence, particularly generative AI, can transform various aspects of housing supply and municipal regulations, according to one embodiment. The image is divided into three sections: (1) Types of AI enablement, highlighting generative models tailored for real estate 1102, showing the global and enterprise knowledge 1104 specific to property development and market trends 1106. (2) AI-Enabled Real Estate Professional, emphasizing the AI's capabilities in innovating property valuation 1108, suggesting subdivision insights 1110, generative research 1114, generative automation 1115, and making data-driven decisions 1112 while upholding safety 1116, ethics 1118, and compliance 1120 within the real estate industry. (3) Transforming Real Estate Work 1122, divided into strategic tasks 1124 like identifying new market opportunities for lot subdivision 1126 and tactical tasks such as streamlining the subdivision process 1128 and optimizing the financial returns of property sales 1130, etc. The visualization could serve as a powerful explanation of Atherton Studios AI's role in pioneering the future of real estate subdivision and development, according to one embodiment. FIG. 11 demonstrates the transformative impact of AI on the real estate industry, particularly in property subdivision, according to one embodiment. The strategic tasks facilitated by AI include identifying new markets for lot subdivision, which could help address housing shortages and unlock new value in real estate assets, according to one embodiment. On the tactical side, Atherton Studios AI streamlines the subdivision process, reducing complexity and costs for homeowners. It also optimizes the financial returns of property sales by providing accurate market analyses and subdivision suggestions, according to one embodiment. This AI integration represents a leap forward in real estate, making subdivision accessible to a broader audience and contributing to more efficient land use, according to one embodiment.

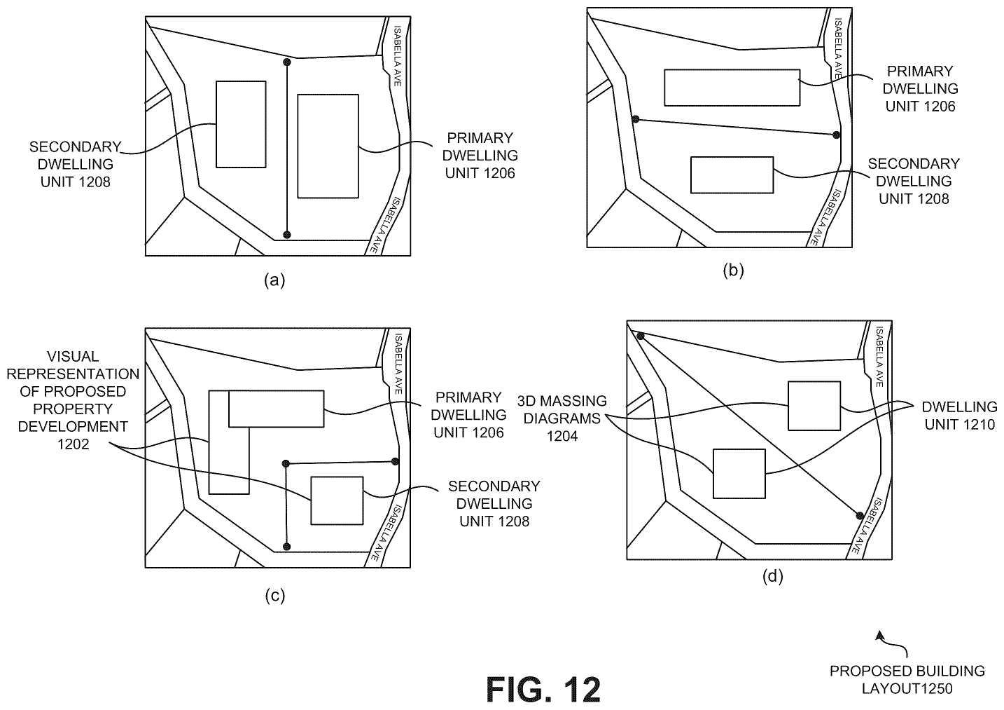

FIG. 12 illustrates the proposed building layout 1250 generated by generative AI-powered lot subdivision optimization and visulization system 100 after recommendation of lot split using the lot splitter module 165 based on the SB9 zoning rules. The recommendation engine 172 may propose the layout considering factors such as ingress and egress options, setback regulations, privacy concerns, etc. for each of the proposed building construction layout. For example, as shown in option (a), the recommendation engine 172 may propose one primary dwelling unit 1206 and a secondary dwelling unit 1208 based on individual preferences considering the potential for a rental income, guest housing, and/or multigenerational living space. In option (b), the recommendation engine 172 may propose a bigger primary dwelling unit 1206 for the property owner and a secondary dwelling unit 1208 for rentals based on privacy requirement, such as creating natural sound barriers and sightline obstructions. In option (c), the recommendation engine 172 may propose a primary dwelling unit 1206 with a smaller secondary dwelling unit 1208 to maximize natural light and promote energy-efficient construction practices according to the property owner's preferences. In option (d), the recommendation engine 172 may propose two equal sized dwelling units 1210 to maximize potential return on investment, according to one embodiment.

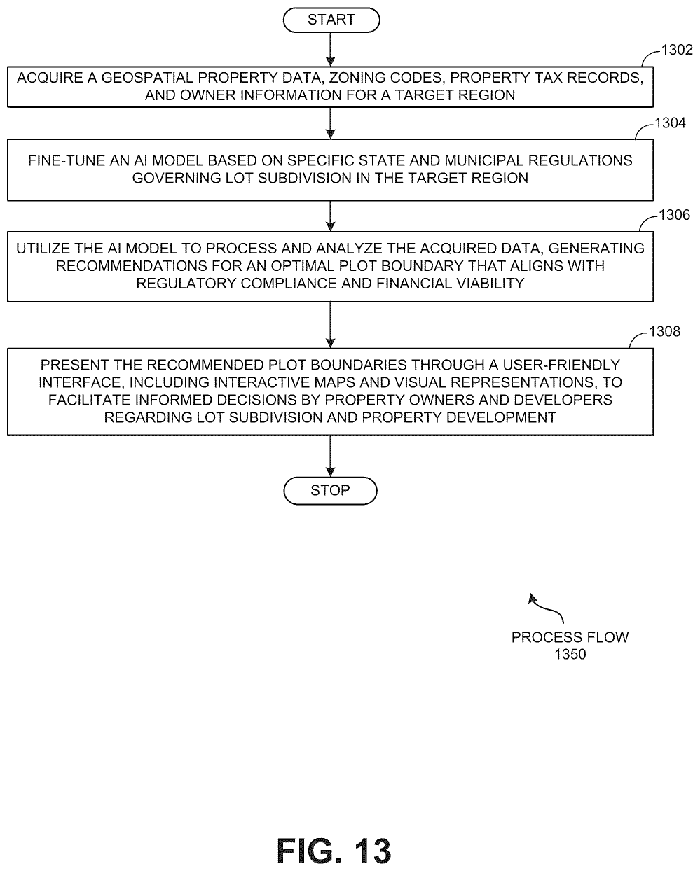

FIG. 13 is a process flow detailing the operations involved in generating an optimal plot boundary using the generative AI lot subdivision and visualization system of FIG. 1, according to one embodiment.

In operation 1302, the generative AI-powered lot subdivision optimization and visulization system 100 may acquire a geospatial property data, zoning codes, property tax records, and owner information for a target region. In operation 1304, the generative AI-powered lot subdivision optimization and visulization system 100 may fine-tune an AI model 174 based on specific state and municipal regulations governing lot subdivision in the target region. In operation 1306, the generative AI-powered lot subdivision optimization and visulization system 100 may utilize the AI model 174 to process and analyze the acquired data, generating recommendations 816 for an optimal plot boundary 805 that aligns with regulatory compliance and financial viability. In operation 1308, the generative AI-powered lot subdivision optimization and visulization system 100 may present the recommended plot boundaries through a user-friendly interface 850, including interactive maps and visual representations, to facilitate informed decisions by property owners and developers regarding lot subdivision and property development, according to one embodiment.

The transformative impact of AI on the real estate industry, particularly in property subdivision, according to one embodiment. The strategic tasks facilitated by AI include identifying new markets for lot subdivision, which could help address housing shortages and unlock new value in real estate assets, according to one embodiment. On the tactical side, Atherton Studios AI streamlines the subdivision process, reducing complexity and costs for homeowners. It also optimizes the financial returns of property sales by providing accurate market analyses and subdivision suggestions, according to one embodiment. This AI integration represents a leap forward in real estate, making subdivision accessible to a broader audience and contributing to more efficient land use, according to one embodiment.

### Plain English Example & More Disclosure

Imagine a sophisticated software platform that combines the functionality of Zillow with advanced AI algorithms to automatically determine the best options for splitting a lot under California's Senate Bill 9 (SB9). This tool would have a user-friendly interface similar to Zillow, where users can input the address of a property. Once the address is entered, the software would utilize a vast database of property records, zoning laws, and SB9 regulations to analyze the potential for splitting the lot.

The key features of this invention include, according to one embodiment:

Interactive Map Interface: Like Zillow, the platform would display an interactive map, allowing users to visually understand the property's context, neighboring plots, and geographical features. The platform would have a user-friendly interface similar to Zillow, where users can enter their property address or navigate a map to find their lot.

Automated SB9 Compliance Check: The tool automatically assesses whether a property is eligible for splitting under SB9 (and similar statutes), taking into account local zoning laws, property size, and other pertinent regulations, according to one embodiment.

Splitting Options Visualization: For eligible properties, the software generates and displays multiple lot-splitting scenarios, according to one embodiment. Each scenario includes detailed information such as the proposed new lot boundaries, potential construction areas, and adherence to local zoning requirements, according to one embodiment. The Atherton Studios AI then generates potential subdivision options, visualizing how the lot could be split, according to one embodiment. This includes suggestions for optimizing space, like creating duplexes or adding ADUs (Accessory Dwelling Units), according to one embodiment.

Regulatory Compliance: The tool automatically checks local zoning laws and SB9 requirements to ensure the proposed subdivisions are compliant, according to one embodiment.

Feasibility and Cost Analysis: It also provides a feasibility study, estimating costs involved in the subdivision, potential construction costs, and the prospective market value of the newly created lots, according to one embodiment.

Customization Features: Users customize their subdivision plans by adjusting parameters like the number of units, size, and design preferences, according to one embodiment.

Professional Consultation Integration: The platform also offers an option to consult with architects, urban planners, or legal professionals for more detailed planning and to navigate the approval process, according to one embodiment.

Community Impact Assessment-optional: Understanding the potential social and environmental impact of the subdivision in the neighborhood aligns with sustainable development goals, according to one embodiment

Interactive Feedback Loop: Users provide feedback on the proposed plans, which the Atherton Studios AI would use to refine and adjust the options, according to one embodiment.

Educational Resources: To assist users, the platform includes educational resources about SB9, property development, and homeownership, according to one embodiment.

3D Modeling and Impact Analysis: The platform could offers 3D modeling of each proposed lot split, giving users a realistic view of the potential development, according to one embodiment. It also analyzes and displays the impact of each split on factors like sunlight, privacy, and neighborhood density, according to one embodiment.

Financial Analysis Tools: Integrating financial tools to estimate the market value of the split lots, potential development costs, and return on investment for each scenario, according to one embodiment.

Community Feedback Integration: A feature to gather and display community feedback on proposed lot splits, promoting transparency and public participation in the development process, according to one embodiment.

Regulatory Update Feed: A continuously updated feed of changes in local and state regulations related to property development under SB9 (and similar statutes), ensuring users always have the most current information, according to one embodiment.

This invention greatly simplifies the process of lot splitting under SB9 (and similar statutes), making it accessible to property owners, developers, and urban planners. It would streamline decision-making, promote efficient land use, and potentially unlock new housing opportunities in urban areas, according to one embodiment.

Atherton Studios AI” essentially democratizes the process of property development under SB9 (and similar statutes), making it accessible and understandable for the average homeowner. Such a tool significantly impact housing availability and affordability in California and other states, aligning with the broader goals of SB9 to address the housing crisis, according to one embodiment.

### Current Embodiments

Advanced Geospatial Analysis: Atherton Studios AI employs state-of-the-art geospatial technology to precisely assess the topography, environmental constraints, and infrastructural elements of each lot, according to one embodiment. This ensures that the subdivision plans are not only viable but also environmentally considerate.

Real-Time Market Data Integration: The tool integrates real-time real estate market data, providing users with insights into current trends, potential rental yields, and the expected property values after subdivision, according to one embodiment. This offers a comprehensive economic outlook for the property development.

3D Modeling and Virtual Tours: Users can take virtual tours of the proposed subdivided lots using 3D modeling, according to one embodiment. This feature is instrumental in visualizing how new structures integrate into the existing landscape, offering a tangible sense of space and layout.

Community Feedback Interface: An integrated platform is available where neighbors and community members can view, understand, and provide feedback on proposed plans, fostering community involvement and proactively addressing potential concerns, according to one embodiment.

Automated Legal and Permitting Guidance: Atherton Studios AI guides users through the legal and permitting processes, including the automated generation of necessary documentation and applications, thereby streamlining bureaucratic procedures, according to one embodiment.

Sustainability and Eco-friendly Recommendations: The tool offers recommendations for sustainable building practices and eco-friendly designs, helping users align with environmental conservation goals and potentially qualify for green incentives or certifications, according to one embodiment.

Customized Financial Planning Tools: Financial planning tools within Atherton Studios AI assist users in understanding financing options, tax implications, and long-term financial forecasting for their subdivided property, according to one embodiment.

Augmented Reality (AR) Integration: Through AR technology, users can project potential subdivisions onto their physical property using a smartphone or tablet, providing a highly immersive and interactive experience, according to one embodiment.

Social Impact Assessment: Atherton Studios AI evaluates the broader social impact of the proposed developments, including effects on local housing availability and diversity, ensuring socially responsible planning, according to one embodiment.

Max FAR (Floor Area Ratio) Consideration: Atherton Studios AI automatically calculates the maximum allowable floor area based on the municipality's FAR regulations. This ensures that any proposed structures are within legal limits, optimizing the use of space while adhering to local laws.

Setback and Privacy Compliance: The tool considers local setback requirements and privacy regulations in its design process. It intelligently adjusts the positioning and orientation of buildings on each subdivided plot to maintain required distances from property lines and neighboring structures, ensuring privacy and adherence to local codes.

Automatic 3D Massing Diagrams: Utilizing advanced algorithms, Atherton Studios AI generates detailed 3D massing diagrams 1204 of the property. These diagrams accurately represent the spatial volume and physical presence of proposed structures on the subdivided lots, giving a clear picture of how the development will materialize in three dimensions.

Integration of Generative AI for Renderings: The tool employs generative AI technology to create realistic renderings of how homes might look on their respective plots. This feature considers architectural styles, materials, and environmental factors, providing a variety of design options that fit within the massing constraints and aesthetic considerations.

Overlay on Actual Property: Using augmented reality (AR) or virtual reality (VR) technology, these renderings and massing diagrams can be overlaid directly onto the physical property. This allows homeowners and developers to visualize the future development in situ, offering a powerful perspective on how the new structures will integrate into the existing environment.

Customization and Iterative Design: Users can customize various aspects of the design, such as building height, facade materials, and layout. The tool's AI adapts to these changes, recalculating massing and updating renderings in real-time, fostering an iterative design process.

Comprehensive Impact Analysis: Beyond mere visualization, Atherton Studios AI analyzes the potential impacts of the proposed development, including shadow studies, line-of-sight analyses, and environmental impacts, ensuring that the development is not only viable but also responsible.

Streamlined Approval Process: By providing detailed and regulation-compliant massing diagrams and renderings, Atherton Studios AI streamlines the approval process with planning departments. Its accuracy and thoroughness in adhering to local codes expedite the review and approval stages

Enhanced Stakeholder Communication: These visual tools enhance communication with stakeholders, including local authorities, neighbors, and potential investors, providing a clear and detailed representation of the proposed development using generative AI.

Educational Aspect: For users unfamiliar with architectural and zoning terminologies, Atherton Studios AI offers educational resources, helping them understand the significance of massing, FAR, setbacks, and other relevant concepts in urban planning using query based responses and generative AI.

### Lot Types and the Application of Atherton Studios AI

The “Atherton Studios AI” can significantly assist in determining the most feasible and efficient ways to subdivide lots of various shapes under SB9 or similar state statutes, according to one embodiment. The Atherton Studios AI uses a combination of zoning regulations, property dimensions, and local market data to evaluate the subdivision potential of each lot type, according to one embodiment. Here's how it would approach each polygon shape type, according to one embodiment:

Corner Lot: The Atherton Studios AI evaluates the potential for splitting based on frontage on two streets. It considers local zoning regulations regarding access and setback requirements, identifying optimal split lines that maximize both street frontages, according to one embodiment.

Rectangular Lot: Generally straightforward to subdivide, the Atherton Studios AI efficiently calculates the division of space, ensuring each new lot complies with size and frontage requirements. It identifies the most marketable and functional subdivision layout, according to one embodiment. Please note: a lot does not (and is usually not perfectly rectangular to qualify as a rectangular lot. The buildability and general conformity with this shape and how professionals would characterize it defines this term and the Atherton Studios AI would be trained on that generalization, according to one embodiment

Trapezoidal Lot: For these lots, the Atherton Studios AI assesses how the non-parallel sides impact potential subdivisions. It uses geometric algorithms to find the best division lines that meet zoning requirements and maintain functional lot shapes.

Oversized Lot: Given their larger size, the Atherton Studios AI analyzes different subdivision scenarios. It optimizes the split to create multiple functional lots while considering existing structures and the potential for maximized land use.

Deep Lot: The Atherton Studios AI examines the depth to provide options for dividing the property. It ensures that each subdivided lot has adequate frontage and backyard space, adhering to local zoning and market preferences.

Irregular Lot: For irregular lots, the Atherton Studios AI runs multiple subdivision simulations to find viable configurations. It considers unique angles and dimensions to create marketable and compliant subdivided plots.

L-Shaped Lot: The Atherton Studios AI navigates the challenges of this shape by exploring creative subdivision solutions. It ensures that each new lot has functional space and adheres to zoning regulations.

T-Shape Lot: The Atherton Studios AI evaluates the limited functionality and appeal of potential subdivisions. It seeks to maximize the usability of each section while adhering to setback and area requirements.

Narrow Lot: These are assessed for their total area and width. The Atherton Studios AI determines if a viable split is possible without compromising the functionality of each new lot and adhering to minimum width requirements.

Cul-de-Sac Lot: The Atherton Studios AI evaluates the limited development options due to the location and shape. It considers local market preferences and zoning limitations in assessing subdivision feasibility.

Pie-Shaped Lot: The Atherton Studios AI analyzes how to divide the wide rear and narrow front in a manner that creates functional and attractive parcels, considering the unique challenges of this shape.

Reverse Pie-Shaped Lot: Similar to pie-shaped lots, but with added complexity due to the narrower back portion. The Atherton Studios AI explores ways to maximize the usability of the narrower section.

Fan-Shaped Lot: The Atherton Studios AI tackles the irregular shape to find subdivision solutions, aiming to create lots with functional layouts despite unconventional dimensions.

Triangular Lot: Generally challenging, the Atherton Studios AI determines if a functional and marketable subdivision is possible, often focusing on maximizing the utility of the broader section.

Hammerhead Lot: The Atherton Studios AI assesses the unique shape to find potential subdivision lines, though the options may be limited due to the unconventional layout.

Flag Lot: Given the narrow access, the Atherton Studios AI evaluates the complexities of sharing or reconfiguring the access. It assesses whether a subdivision is feasible without compromising the functionality and appeal of the lots.

In cases where a lot may not be subdividable, such as insufficient frontage, zoning restrictions, or the presence of a large, newly built home, the Atherton Studios AI identifies these constraints and advises accordingly. It also considers economic feasibility, ensuring that the proposed subdivision makes sense from a market and investment perspective. This comprehensive approach allows “Atherton Studios AI” to provide valuable guidance in the complex process of lot subdivision under SB9 (and similar statutes).

How the Commerical Implementation Would Work in a Preferred Embodiment

The Atherton.com platform, enhanced by the Atherton Studios AI, offers a user-friendly, Zillow-like interface that revolutionizes the process of land subdivision for property owners. Here's a detailed description of how this innovative platform works:

Search Functionality: Users can search for any plot of land by address. The Atherton Studios AI then automatically evaluates the property based on its location, size, shape, and local zoning laws.

Subdivision Suggestions: Upon analyzing the plot, the AI suggests feasible ways to subdivide the land in accordance with state law, such as SB9. If a plot cannot be subdivided due to various constraints like zoning restrictions, insufficient frontage, or other limitations, the AI explains these reasons clearly.

Interactive Details Page: A detailed page allows users to interactively adjust the recommended lot sizes within legal limits (e.g., a 60%/40% split under SB9). Users can modify plot boundaries while the AI ensures these changes still comply with state and local regulations.

Visual Indicators for Economic Feasibility: The interface includes visual indicators that show whether the proposed division is economically feasible and legally subdividable. This feature assists users in making informed decisions about potential subdivisions.

Polygon Shape Identification Module 536: This module identifies the optimal shape for each subdivided lot based on the plot's current shape, intended use, and marketability. It ensures that each new lot is both functional and attractive.

A-Estimate Score: The AI calculates an estimated value for the lots if they are split, illustrating the potential increase in property value. This proprietary A-Estimate Score gives landowners a visual and easy-to-understand metric to gauge the financial benefit of subdividing their property.

Listing and Selling on Atherton Studios: Users have the option to list their current lot and the potential subdivided lots for sale directly on Atherton Studios. This feature streamlines the process of selling subdivided land, connecting landowners with potential buyers efficiently.

Ecommerce Checkout for Splitting Services: Through an integrated ecommerce checkout system, users can purchase services to officially split their lots with the municipality. This service includes professional assistance empowered by the Atherton Studios AI, which ensures that the subdivision process is smooth, compliant with legal requirements, and optimally designed for market appeal

3D Rendering of Massing Diagrams: Once the Atherton Studios AI determines a feasible subdivision plan, the platform generates 3D massing diagrams 1204 for each potential lot. These diagrams visually represent the spatial volume and layout of proposed structures, considering the maximum FAR (Floor Area Ratio) and setback requirements as analyzed by the AI.

Visualization of Potential Homes: Alongside massing diagrams, the platform uses advanced rendering technology to create realistic 3D models of how homes might look on the subdivided lots. This feature incorporates architectural styles, materials, and environmental settings to provide a lifelike representation of the potential development. The Atherton Studios AI can even produce a budget, timeline to create the home, and create an ecommerce mechanism to hire a general contracting service to actually make the home a reality.

Customization Options: Users can interact with these 3D models, experimenting with different design elements, such as roof types, exterior finishes, and landscaping features. This customization allows users to personalize the proposed development and visualize various architectural possibilities.

Integration with Setback and FAR Analysis: The 3D models are directly integrated with the setback and FAR (Floor to Area Ratio) analysis previously conducted by the AI. This ensures that all renderings are not only aesthetically pleasing but also compliant with local zoning laws and SB9 regulations.

Interactive Experience: The platform offers an interactive experience where users can virtually navigate through the 3D models, offering a comprehensive view of how the subdivision and new structures will integrate into the existing landscape.

Real-Time Adjustments: As users adjust the percentage of recommended lot sizes or modify plot boundaries, the 3D renderings update in real-time to reflect these changes. This dynamic feature allows users to immediately see the impact of their decisions on the potential development.

Augmented Reality (AR) Feature: Users can also utilize an AR feature to overlay these 3D renderings onto their current property using a smartphone or tablet. This provides a highly immersive and tangible sense of how the subdivided and developed property would exist in the real world.

Decision-Making Tool: These 3D renderings serve as a powerful decision-making tool, enabling users to visualize the end result of the subdivision and development process before committing to any changes. It helps in assessing the aesthetic and functional aspects of the proposed plans. By offering these advanced 3D rendering capabilities, Atherton.com empowers property owners to fully understand and visualize the potential of their land under SB9 (and similar statutes). This feature not only enhances the user experience but also provides valuable insights into the architectural and economic implications of subdividing and developing a property.

In essence, Atherton.com, powered by the Atherton Studios AI, offers a comprehensive, end-to-end solution for land subdivision. It simplifies complex legal and zoning considerations, provides valuable financial insights, and offers a seamless platform for listing and selling subdivided property. This powerful combination of AI technology and user-friendly interface democratizes the process of land development, making it accessible to a wider range of property owners.

### Streamlining Process from Online Lot Split to Planning Approval

The “Atherton Studios AI,” a generative AI tool, can significantly streamline and automate many steps in the lot splitting process under SB9 (and similar statutes), thereby reducing labor costs and increasing efficiency, according to one embodiment. Atherton Studios may charge a fee for this service (e.g., $10,000), according to one embodiment. Some of the automation can be done with the Atherton Studios AI, whereas others may require human effort.

Initial Research and Consultation: The Atherton Studios AI can analyze local zoning laws and SB9 regulations using natural language processing (NLP) and provide a summary of pertinent regulations, according to one embodiment. Training of the Atherton Studios AI on a diverse dataset of municipal codes, zoning laws, and SB9 documentation, according to one embodiment. Professionals would still need to validate the Atherton Studios AI's interpretation and provide context-specific advice.

Boundary Survey: The Atherton Studios AI could analyze existing survey data and satellite imagery to preliminarily map property boundaries, according to one embodiment. Training on geospatial data and existing survey records using the Atherton Studios AI, according to one embodiment. A licensed surveyor would still be required for official boundary delineation and to verify AI-generated maps.

SB9 Tentative Map: The Atherton Studios AI can generate initial tentative map drafts based on property data, zoning requirements, and user inputs, according to one embodiment. Integration with GIS systems and training on a variety of subdivision plans, according to one embodiment. Civil engineers or planners would review and refine these drafts to ensure compliance and feasibility.

Arborist Report: The Atherton Studios AI could analyze drone imagery to identify tree species and assess their health, according to one embodiment. Training of the Atherton Studios AI on a dataset of tree species, health indicators, and environmental impact assessments, according to one embodiment. An arborist would need to conduct a physical inspection to confirm findings and provide expert recommendations.

Soils Report: Using the Atherton Studios AI, the system could create preliminary soil analysis using historical data and predictive modeling to indicate potential soil conditions, according to one embodiment. Training on geotechnical data and historical soil reports. Geotechnical engineers would conduct onsite testing to validate AI predictions and draft the official soils report, according to one embodiment.

Environmental Impact Assessment: Using the Atherton Studios AI, the system could conduct initial environmental impact assessments based on available environmental data and predictive models, according to one embodiment. Training of the Atherton Studios AI on environmental impact data, including local ecosystems, biodiversity, and previous assessments, according to one embodiment. Environmental experts would review and supplement these assessments with on-site evaluations.

Design and Architectural Plans: Using the Atherton Studios AI, the tool can use generative AI to create multiple architectural design options that comply with local regulations, according to one embodiment. Training of the Atherton Studios AI on architectural design principles, zoning regulations, and user preferences, according to one embodiment. Architects would refine these AI-generated designs to ensure practicality and alignment with client desires.

Community Outreach: The Atherton Studios AI could use generative AI to analyze community feedback from various channels and summarize concerns or trends, according to one embodiment. NLP training of the Atherton Studios AI on community engagement data, feedback analysis, according to one embodiment. Developers and community planners would still need to engage directly with the community for discussions and consensus building.

Application Submission: The Atherton Studios AI could use generative AI to automate the compilation and initial drafting of application documents based on collected data and reports, according to one embodiment. Training of the Atherton Studios AI on a wide range of regulatory documents and application procedures, according to one embodiment. Legal and planning professionals would review and submit the final application.

Review Process: The Atherton Studios AI could use generative AI to assist in tracking and managing the application review process, providing updates and flagging outstanding issues, and automatically addressing concerns and suggesting improvements as well as drafting response letters, according to one embodiment. Integration with municipal systems and training on bureaucratic process management, according to one embodiment. Human effort would still be needed with continuous monitoring and correspondence with the municipality by the project team.

Addressing Feedback and Revisions: The Atherton Studios AI could use generative AI to analyze feedback from the municipality and suggesting necessary revisions, according to one embodiment. NLP training on regulatory feedback and revision suggestions, according to one embodiment. Professionals would implement these revisions in the plans and documents.

Approval and Final Map: Upon approval, AI can automatically update tentative maps to final maps based on provided guidelines, according to one embodiment. Training on cartographic standards and regulatory requirements, according to one embodiment. A certified professional would verify and officially record the final map.

Permitting for Construction: Preparing initial drafts of permit applications and checking for compliance with building codes, according to one embodiment. Training on building codes and permit application processes, according to one embodiment. Professional review and submission of permits, with possible on-site inspections.

Construction and Final Inspection: AI could manage project timelines, budget tracking, and coordination between contractors, according to one embodiment. Training on project management algorithms and construction processes, according to one embodiment. Physical construction and final inspection by certified building inspectors.

In each of these steps, “Atherton Studios AI” acts as a powerful assistant, automating initial analyses, generating drafts, and managing data, according to one embodiment. However, human expertise remains integral to validate AI-generated outputs, provide context-specific insights, and perform tasks that require professional judgment and physical presence, according to one embodiment. This combination of AI and human expertise ensures both efficiency and reliability in the lot splitting process under SB9 (and similar statutes), and similar statutes across different states in the United States, according to one embodiment.

### Contemplated Future Embodiments

Utilize Atherton Studios AI to create virtual staging of properties, allowing users to see potential home designs on vacant lots, according to one embodiment. Assess and visualize the impact of new developments on historic neighborhoods, according to one embodiment. Offer predictive market analysis and investment insights for potential buyers looking for profitable opportunities, according to one embodiment. Offer real-time analytics on real estate trends, price predictions, and growth areas through advanced AI algorithms, according to one embodiment. An AI tool to help users navigate complex local regulations and ensure their property modifications are compliant, according to one embodiment. Suggest optimal smart home setups and integrations for newly designed or existing homes, enhancing efficiency and lifestyle quality, according to one embodiment.

### Plain English Example

Let's envision an 80-year-old widow named Margaret, living in Menlo Park. She's not computer savvy, but her neighbors have mentioned how Atherton Studios AI could help her financially. With the help of her granddaughter, she visits Atherton.com. They enter her address and the AI automatically suggests a subdivision of her large property, providing a 3D rendering of potential new homes on the subdivided lots. Margaret learns that by splitting her property, she could sell the new lots for significant value while keeping her existing home. The AI's A-Estimate Score indicates a substantial increase in property value post-subdivision. She's delighted to know she could sell the lots and secure her comfortable living without having to move away from her cherished home.

Her granddaughter assists her in using the ecommerce checkout to engage Atherton Studios' services to handle the subdivision officially, ensuring Margaret has a hassle-free experience and can maximize the financial benefit from her property.

### Best Mode Disclosure

Atherton Studios AI is catalyzing the creation of more affordable housing units, addressing California's housing shortage (as well as other similarly situated states) by simplifying the subdivision process, according to one embodiment. Besides California, states like Oregon and Minnesota have been facing severe housing shortages and have taken legislative action to address the issue. Oregon has the largest housing supply deficit at nearly 9%, followed by California with nearly 6%. Other states have also begun tackling the problem; for instance, North Carolina has passed legislation to eliminate exclusive single-family zoning, which restricts housing development to only one type of housing. By removing these zoning restrictions, these states aim to give builders more flexibility to create a range of housing options and alleviate the shortage.

The tool empowers homeowners to become effective contributors to solving the housing crisis, turning them into micro-developers and unlocking new economic potentials, according to one embodiment. With its community feedback feature, Atherton Studios AI promotes harmonious neighborhood development and reduces potential conflicts, ensuring community engagement, according to one embodiment.

Homeowners utilize Atherton Studios AI to monetize their property, either through rental income or by selling subdivided lots, thus opening new economic avenues, according to one embodiment. The tool's focus on sustainable development practices aligns with environmental stewardship, promoting greener urban living spaces, according to one embodiment. Atherton Studios AI serves as a model for future urban planning tools, integrating technology with legislative frameworks to foster smarter, more inclusive city development, according to one embodiment. By providing accessible resources and information, Atherton Studios AI enhances public awareness about urban development, property rights, and sustainable living, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A land-use planning system, comprising:
a data collection module configured to extract a shape file associated with a property address of a plot of real property in a jurisdiction,
wherein the shape file to include at least one of a location, a geometry, and attribution of a point, a line, and a polygon features of the plot of real property;
an artificial intelligence (AI) model adapted to analyze the shape file, wherein the AI model is fine-tuned based on a regulation governing lot subdivision in the jurisdiction;
a recommendation engine integrated with the AI model to generate an optimal plot boundary suggestion to adhere to the governmental regulation while maximizing financial viability of split lots from the property address; and
a visualization component to create a visual representation of the split lots in the jurisdiction displaying the optimal plot boundary suggestion on a rendering of the shape file.

2. The system of claim 1 further comprising:
a data preprocessing component configured to standardize and clean the collected geospatial property information, zoning regulations, property tax records, and owner data using a zoning classification module.

3. The system of claim 1, wherein the AI model's fine-tuning is continuously updated to accommodate changes in state and municipal regulations related to lot subdivision.

4. The system of claim 1, wherein the recommendation engine to consider additional factors, including at least one of a property age, market trends, and demographic data, when generating the optimal plot boundary suggestions to maximize financial viability.

5. The system of claim 1, wherein the visualization component to generate the 3D massing diagrams that adhere to local zoning and planning guidelines, showcasing the proposed lot divisions in a visually compelling manner.

6. The system of claim 1, further comprising transmitting the recommended optimal plot boundaries to property owners and developers via electronic communication for review and consideration.

7. The system of claim 1, wherein the fine-tuning of the AI model involves adjusting hyperparameters, including learning rates and batch sizes to optimize its performance for the lot subdivision recommendations.

8. The system of claim 1, wherein the data collection module to use a generative AI module to allow users to input data in a plain language.

9. The system of claim 1, wherein a user interface of the visualization component allows for an interactive query about a plot boundary adjustment and provides a realtime AI-generated feedback.

10. The system of claim 1, further comprising a feature to generate an executive summary using a generative AI to explain a rationale behind the plot boundary recommendations.

11. The system of claim 1, further comprising an integrated market analysis module to leverage a real-time real estate market data to provide the user with predictions on the future value of the subdivided lot for making an informed decision on selling and developing a lot.

12. The system of claim 1, further comprising a community impact assessment tool to analyze and predict the impact of the proposed lot split on the local community, including effects on traffic, schools, and public services for presentation to at least one of a zoning board and a community group.

13. The system of claim 1, further comprising an environmental module implemented using the AI to identify and preserve natural features on the lot, such as trees, water bodies, and topography to ensure that lot subdivision plans are environmentally sustainable.

14. The system of claim 1, wherein the generative AI to include a VR capabilities to allow the user to “walk through” the proposed subdivided lots and surrounding areas, providing a more tangible understanding of the space and its potential.

15. The system of claim 1, wherein the generative AI to:
automatically generate the necessary legal and regulatory documents for submission based on the proposed lot split plan to simplify the process of obtaining approvals,
automatically suggest lot split plans that preserve the historical character of the property while still meeting modern development needs based on an AI-driven analysis,
equally led with data to analyze natural disaster data and suggest lot split plans that enhance the resilience of homes and infrastructure to at least one of the events such as floods, wildfires, and earthquakes,
integrate with utility mapping and analysis to ensure that subdivided lots optimize the use of existing infrastructure, such as water, sewer, and electrical grids, and plan for the efficient placement of new services,
utilize a specialized algorithm to propose the placement of ADUs on existing lots, considering the potential for at least one of a rental income, guest housing, and/or multigenerational living space,
suggest negotiation strategies for property owners to use with at least one of a neighbor and a local authority based on previous successful negotiations and current regulatory environments, and
customize an aesthetic algorithm to suggest lot divisions based on aesthetic preferences, incorporating architectural styles, sightlines, and other design elements that align with the character of an existing neighborhood.

16. A method for recommending optimal plot boundaries in a lot subdivision, comprising:
collecting a geospatial property information, a zoning regulation, a property tax records, and an owner data;
training an AI model to process said geospatial property information, wherein the AI model is fine-tuned based on a state and a municipal regulation governing the lot subdivision;
employing the AI model to analyze the collected data and generate recommendations for optimal plot boundaries while ensuring compliance with the said state and municipal regulation; and
visualizing the recommended plot boundaries, including generating a 3D massing diagram to aid in decision-making by at least one of a property owner and a developer.

17. The method of claim 16, further comprising:
configuring a data preprocessing component to standardize and clean the collected geospatial property information, zoning regulations, property tax records, and owner data.

18. The method of claim 16, further comprising:
continuously updating the AI model's fine tuning to accommodate changes in the state and municipal regulations related to the lot subdivision.

19. The method of claim 16, further comprising:
considering at least one of the additional factors, including a property age, a market trend, and a demographic data, when generating optimal plot boundary suggestions to maximize financial viability using a recommendation engine.

20. The method of claim 16, further comprising:
generating the 3D massing diagram that adheres to local zoning and planning guidelines, showcasing the proposed lot divisions in a visually compelling manner using a visualization component.

21. The method of claim 16, further comprising:
transmitting the recommended optimal plot boundaries to property owners and developers via electronic communication for review and consideration.

22. The method of claim 16, further comprising:
monitoring real-time data to identify changes in property values, zoning regulations, and market conditions, and updating the AI model's fine-tuning accordingly.

23. A computer-implemented method for optimizing lot subdivision, comprising:
acquiring a geospatial property data, zoning codes, property tax records, and owner information for a target region;
fine-tuning an AI model based on specific state and municipal regulations governing lot subdivision in the target region;
utilizing the AI model to process and analyze the acquired data, generating recommendations for an optimal plot boundary that aligns with regulatory compliance and financial viability; and
presenting the recommended plot boundaries through a user-friendly interface, including interactive maps and visual representations, to facilitate informed decisions by property owners and developers regarding lot subdivision and property development.

24. The computer-implemented method for optimizing lot subdivision of claim 23, further comprising:
configuring a data preprocessing component to standardize and clean the collected geospatial property information, zoning regulations, property tax records, and an owner data.

25. The computer-implemented method for optimizing lot subdivision of claim 23, further comprising:
continuously updating the AI model's fine tuning to accommodate changes in the state and municipal regulations related to the lot subdivision.

26. The computer-implemented method for optimizing lot subdivision of claim 23, further comprising:
considering at least one of the additional factors, including a property age, a market trend, and a demographic data, when generating optimal plot boundary suggestions to maximize financial viability using a recommendation engine.

27. The computer-implemented method for optimizing lot subdivision of claim 23, further comprising:
generating a 3D massing diagram that adheres to local zoning and planning guidelines, showcasing the proposed lot divisions in a visually compelling manner using a visualization component.

28. The computer-implemented method for optimizing lot subdivision of claim 23, further comprising: transmitting the recommended optimal plot boundaries to property owners and developers via electronic communication for review and consideration.

29. The computer-implemented method for optimizing lot subdivision of claim 23, wherein the geospatial property data includes at least one of a topographic map, an aerial imagery, and property dimensions for comprehensive property analysis.

30. The computer-implemented method for optimizing lot subdivision of claim 23, wherein the user-friendly interface provides a dynamic platform for property owners and developers to interactively explore recommended plot boundaries and adjust parameters to visualize the impact on financial viability and regulatory compliance.

31. The computer-implemented method for optimizing lot subdivision of claim 23, further comprising generating an executive summary using generative AI technology, explaining the rationale behind the AI model's recommended plot boundaries, and providing transparent insights to property owners and developers.

32. The computer-implemented method for optimizing lot subdivision of claim 23, further comprising:
automatically generating a collateral to explain the lot subdivision process and its importance to the public and neighbors, potentially fostering a better understanding and acceptance of new developments,
integrating the natural language processing and generative AI throughout the optimizing lot subdivision method to allow users to interact conversationally with the system, receive detailed recommendations, and
manipulate visual representations through verbal commands, enhancing the overall user experience and decision-making process,
automatically adapting to the changing zoning laws and regulations in order to help users to anticipate and prepare for future regulatory shifts using an adaptive zoning compliance engine, and
utilizing a dedicated tool within the system to ensure every lot split proposal includes adequate green space, contributing to the sustainability and livability of both split parcels on a split lot.

33. The computer-implemented method for optimizing lot subdivision of claim 23, further comprising:
creating a lot matchmaking service to match available split lots with potential buyers and developers, taking into account the buyers' preferences and the lots' characteristics,
developing an automated compliance checklist for the property owners and developers to use in order to ensure every aspect of the lot split meets local regulations before submission,
customizing a privacy settings algorithm to suggest lot division based on individual privacy preferences, such as creating natural sound barriers and sightline obstructions,
configuring an energy-efficiency optimizer to suggest lot orientations and divisions to maximize natural light and promote energy-efficient construction practices, and
utilizing the augmented reality plot visualization to overlay proposed lot split boundaries onto physical land, allowing users to visualize changes in real-time on-site.

34. The computer-implemented method for optimizing lot subdivision of claim 23, further comprising:
providing estimates of property taxes for subdivided lots based on the historical tax data and projected valuations using an AI-driven property tax estimator tool,
translating the lot split data and regulations into different languages to make the system accessible to international markets,
assessing the profitability of developing the split lot, including potential return on investment calculations for different development scenarios using a lot split investment analyzer, and
offering regular updates on changes in laws and policies relevant to property lot split for keeping users informed and prepared for future regulations concerning their property.
